(19) United States
(12) Patent Application Publication
(10) Pub. No.: US 2025/0249586 A1
(43) Pub. Date: Aug. 7, 2025

(54) MOTION PLANNING AND CONTROL FOR ROBOTS IN SHARED WORKSPACE EMPLOYING LOOK AHEAD PLANNING

(71) Applicant: REALTIME ROBOTICS, INC., Boston, MA (US)

(72) Inventors: Sean Murray, Victor, MT (US); Peter Englert, Berlin (DE); Arne Sieverling, Berlin (DE); Ty Tremblay, Melrose (MA)

(21) Appl. No.: 18/854,236

(22) PCT Filed: Apr. 3, 2023
(86) PCT No.: PCT/US2023/017296

§ 371 Date: Oct. 4, 2024

Related U.S. Application Data
(60) Provisional application No. 63/327,917, filed on Apr. 6, 2022.

(51) Int. Cl. B25J 9/16

(52) U.S. Cl. CPC B25J 9/1666; B25J 9/161; B25J 9/1682

(57) ABSTRACT

The structures and algorithms described herein employ look ahead motion planning, in which motion planning for a least two goals is performed before a robot executes the resulting motion plans, and the ability to transition between the preceding one of the motion plans to a subsequent (e.g. following) one of the motions plans is assessed. Thus, the system can determine whether a robot will get trapped (e.g., blocked by another robot) at the end of a first motion plan, preventing, limiting or delaying execution of a second motion plan. Detection of such a condition can cause one or more remedial actions can be taken, for example generating a new, revised or replacement first motion plan. Other remedial action can moving another robot, performing motion planning for the other robot, to alleviate a blocking condition and/or determining a new order for the goals.

### CROSS-REFERENCE TO RELATED APPLICATION

This patent application claims priority of U.S. Patent Application No. 63/327,917, filed on Apr. 6, 2022, the entire disclosure of which is hereby incorporated by reference herein for all purposes.

### Technical Field

The present disclosure generally relates to robot motion planning and control of robots, and in particular to systems and methods that perform collision detection via processor circuitry to produce motion plans to efficiently drive robots and the like in shared workspaces.

### BACKGROUND

### Description of the Related Art

Motion planning is a fundamental problem in robot control and robotics. A motion plan specifies a path that a robot can follow to transition from a starting state or current state to a goal state, typically to complete a task without colliding with any obstacles in an operational environment or with a reduced possibility of colliding with any obstacles in the operational environment. Challenges to motion planning involve the ability to perform motion planning at very fast speeds even as characteristics of the environment change. For example, one or more characteristics such as location and/or orientation of one or more obstacles in the environment may change over time during a runtime of the robot(s). Challenges also include generating motion plans that allow robots to complete tasks efficiently for instance with respect to a duration of time to complete the task(s) and/or with respect energy expended to complete the task(s). Challenges further include performing motion planning using relatively low cost equipment, at relative low energy consumption, and with limited amounts of storage (e.g., memory circuits, for instance on processor chip circuitry).

One problem in robotics is operation of two or more robots in a shared workspace (workspaces are commonly referred to as workcells or environments), for example where the robots or robotic appendages of the robots may interfere with one another during the performance of tasks.

One approach to operating multiple robots in a common workspace can be called a task-level approach. The task level approach may employ teach-and-repeat training. An engineer may ensure that the robots are collision-free by defining shared parts of the workspace, and programming the individual robots such that only one robot is in a shared workspace at any given point in time. For example, when a first robot begins to move into a workspace, the first robot sets a flag. A controller (e.g., microprocessor, microcontroller, programmed logic controller (PLC)) reads the flag and prevents other robots from moving into the shared workspace until the first robot de-asserts the flag on exiting the workspace. This approach is intuitive, simple to understand, implement, and troubleshoot. However, this approach necessarily has low work throughput since the use of task-level de-confliction usually leads to at least one of the robots being idle for significant portions of time, even if it would technically be possible for the idle robot to be performing useful work in the shared workspace.

Another approach to operating multiple robots in a common workspace employs offline planning (e.g., during a configuration time preceding the runtime), in order to achieve higher work throughput than in the afore-described task-level de-confliction based approach. To do so, a system may attempt to solve a planning problem in a combined joint space of all robots or robotic appendages. For example, if two 6 degrees-of-freedom (DOF) appendages are in a workspace, a 12 DOF planning problem must be solved. While this approach allows higher performance, the planning can be extremely time consuming. 12 DOF problems appear too large for conventional motion planning algorithms to solve using currently available architectures.

One strategy to address these problems is to optimize motion for a first robot/robotic appendage, and then manually optimize motion for a second robot/robotic appendage. This may employ iteratively simulating motion to ensure that the robots/robotic appendages do not collide with one another, which may take many hours of computation time. Additionally, if a modification to the workspace results in a change in a trajectory of one of the robots/robotic appendages, the entire workflow must be re-validated.

### BRIEF SUMMARY

Motion planning is performed to determine or generate motion plans that can be executed by a given robot to perform one or more tasks. The motion plan can specify a set of poses for the given robot to transition through to achieve a goal, for instance to, or as part of, performing a task. Each pose can, for example, be specified by a set of joint angles which define a physical configuration of one or more portions (e.g., links of an appendage, end effector or end of arm tool) of the robot, and which can be mapped into real world space. A motion plan can, for instance, specify a pose which positions at least a portion (e.g., end effector or end of arm tool) of the given robot at a goal to perform or execute an assigned task. Motion planning for a given robot can take into account a position, trajectory and/or expected trajectory of one more other robots operating in a shared workspace.

The structures and algorithms described herein employ look ahead motion planning in which motion planning for a least two successive goals is performed before a robot executes the resulting motion plans, and the ability to transition between a preceding one of the motion plans to a subsequent (e.g., following or next) one of the motions plans is assessed. Thus, the system can determine whether a robot will get trapped (e.g., blocked by another robot) or even deadlocked at the end of execution of a first motion plan, preventing, limiting or delaying execution of a second motion plan. In response to detection of such a condition the structures and algorithms described herein can cause one or more remedial actions to be taken, for example generating a new, revised or replacement first motion plan. Other remedial actions can include moving another robot and/or performing motion planning for the other robot, to alleviate a blocking or potential blocking condition and/or determining a new order of a set of goals, the set of goals including the first goal and at least the second goal.

The structures and algorithms described herein can advantageously perform motion planning to: i) determine a first motion plan to move a given robot from one pose to a first end pose, the first end pose which locates at least a portion of the first robot at a first goal; and ii) determine at least a second motion plan to move the given robot from the first end pose to a second end pose, the second motion plan determined before causing the first robot to move, for example according to the first motion plan or a revised first motion plan. Such can, for example, allow motion planning for two or more goals to be performed before a given robot executes the motion plans. Such can, for instance, allow the system to consider how one or more subsequent motion plans for respective goals affect one or more preceding motion plans (e.g., the subsequent motion plan being a next motion plan, that is a motion plan that would be executed most immediately following an execution of the preceding motion plan). Various remedial actions can be taken in response to a determination that another robot (e.g., a second robot) will block or likely will block a movement of the given robot (e.g., a first robot). For example, where execution of a first motion plan would cause the given robot to be in a pose that renders it impossible or difficult to execute or even delays execution of the subsequent motion plan (e.g., trapped, deadlock, blocked or likely blocked by another robot), one or more remedial actions can be taken.

The remedial action can, for instance, include generation of a new or revised or replacement motion plan to transition to the first goal but with the first robot in a different end pose than the end pose of the previously generated first motion plan. The new or revised or replacement motion plan can, for example, result in a pose at the first goal that better configures or orients the given robot to achieve a next or subsequent goal (e.g., second goal). The new or revised or replacement motion plan can, for example, result in a pose at the first goal that improves an ability or likelihood of executing a next motion plan to achieve a next or subsequent goal by the given robot. The new or revised or replacement motion plan can, for example, result in a pose at the first goal that allows transition between movement specified by the new or revised or replacement motion first motion plan to movement specified by the next motion plan.

A remedial action can, for instance, include causing another robot that is blocking or likely blocking the given robot to move so as to not block or no longer block a trajectory of the given robot in executing the next or subsequent motion plan.

A remedial action can, for instance, include generating a motion or revised motion plan for another robot that specifies a trajectory for the other robot that will not block or likely will not block the given robot as the given robot moves along a trajectory specified by its motion plan or otherwise reduce the probability of a collision occurring between the given robot and other robots.

A remedial action can, for instance, include determining or generating a new order of a set of goals, the set of goals including the first goal and at least the second goal.

The various techniques described herein can advantageously facilitate the operation of two or more robots operating in a shared workspace or workcell, preventing or at least reducing the risk that robots or robotic appendages of robots will collide with one another while operating to efficiently move one or more robots respectively to one or more goals to perform respective tasks in the shared workspace.

The structures and algorithms described herein enable high degree of freedom robots to avoid collisions and continue efficiently working in a changing, shared environment. An efficient planning method can be accelerated with or without hardware acceleration, to produce collision-free motion plans in milliseconds. Ultrafast “real-time” motion planning allows robot paths to be decided at runtime during task execution, without the need for training or time-intensive path optimization. Such can advantageously allow coordination of multiple robots in a shared workspace in an efficient manner.

The structures and algorithms described herein may, in at least some implementations, result in efficient, collision-free robot movement for a robot in a workspace shared by multiple robots. Collision-free motion may result for all parts (e.g., base, robotic appendages, end-of-arm tools, end effectors) of the robots, even when operating at high velocity.

The structures and algorithms described herein may advantageously reduce programming effort for multi-robot workspaces, by performing autonomous planning, for example during a runtime of one or more robots. In at least some implementations, operators do not need to program any safety zones, time synchronization, or joint-space trajectories. Input may be limited to a description of the task(s) to be performed or goal poses or goals and kinematic models of the robots. Input may additionally include representations of fixed objects, or optionally objects with unpredictable trajectories (e.g., people).

The structures and algorithms described herein may advantageously dynamically perform motion planning, including taking into consideration the effect of a motion plan for a next goal on the motion plan for a preceding goal, and taking remedial action if warranted to efficiently move the robot though various poses to achieve successive goals in order to perform one or more tasks with no or a low probability of collision.

The structures and algorithms described herein may, in at least some implementations, allow robots to share information, for example via a non-proprietary communications channel (e.g., Ethernet connection), which may advantageously facilitate integration of robots in a shared workspace, even robots from different manufacturers.

The structures and algorithms described herein may, in at least some implementations, operate without cameras or other perception sensors. In at least some implementations, coordination between the robots relies on the kinematic models of the robots, the ability of the robots to communicate their respective motion plans, and geometric models of a shared workspace. In other implementations, visual or other perception may optionally be employed, for example to avoid humans or other dynamic obstacles, for instance other robots, that might enter or occupy portions of the shared workspace.

A wide variety of algorithms are used to solve motion planning problems. Each of these algorithms typically need to be able to determine whether a given pose of a robot or a motion from one pose to another pose results in a collision, either with the robot itself or with obstacles in the environment. Collision assessment or checking can be performed “in software” using processors that execute processor-executable instructions from a stored set of processor-executable instructions, to perform an algorithm. Collision assessment or checking can be performed “in hardware” using a set of dedicated hardware circuits (e.g., collision checking circuits implemented in a field programmable gate array (FPGA), application specific integrated circuit (ASIC)). Such circuits may, for example, represent volumes swept by a robot/robotic appendage or portion thereof (i.e., swept volumes) during a respective motion or transition between two states. The circuits may, for example, produce a Boolean evaluation indicative of whether a motion will collide with any obstacles, where at least some of the obstacles represent volumes swept in executing a motion or transition by the other robots operating in the shared workspace.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a robotic system that includes a plurality of robots that operate in a shared workspace to carry out tasks, and which includes motion planners that dynamically produce motion plans for the robots that take into account the planned motions of the other ones of the robots, and which optionally includes a perception subsystem, according to at least one illustrated implementation.

FIG. 2 is a functional block diagram of an environment in which a first robot is controlled via a robot control system that includes a motion planner, optionally provides motion plans to other motion planners of other robots, and further includes a source of planning graphs that can be separate and distinct from the motion planners, according to at least one illustrated implementation.

FIG. 3A is an example motion planning graph for a robot that operates in a shared workspace with a path between a current node representing a current pose and a first goal and a corresponding first pose which positions a robot or portion thereof at the first goal, according to at least one illustrated implementation.

FIG. 3B is an example motion planning graph for the robot that operates in a shared workspace with a path between the first goal node and a second goal and a corresponding second pose which positions the robot or portion thereof at the second goal, according to at least one illustrated implementation.

FIG. 3C is an example motion planning graph for the robot that operates in a shared workspace with a new, or revised or replacement path between the current node representing the current pose and the first goal and a corresponding alternative first pose which positions the robot or portion thereof at the first goal, according to at least one illustrated implementation.

FIG. 3D is an example motion planning graph for the robot that operates in a shared workspace with another new, or revised or replacement path between the current node representing the current pose and the first goal and a corresponding alternative first pose which positions the robot or portion thereof at the first goal, according to at least one illustrated implementation.

FIG. 4 is a flow diagram showing a method of operation in a processor-based system to produce motion planning graphs and swept volumes, according to at least one illustrated implementation.

FIG. 5 is a flow diagram showing a method of operation of a processor-based system to control one or more robots, for example during a runtime of the robots, according to at least one illustrated implementation.

FIG. 6A is a high level flow diagram showing a method of operation of a processor-based system to perform motion planning for one or more robots, for example during a runtime of the robots, according to at least one illustrated implementation, executable as part of performing the method of FIG. 5.

FIG. 6B is a low level flow diagram showing a method of operation of a processor-based system to perform motion planning for one or more robots, for example during a runtime of the robots, according to at least one illustrated implementation, executable as part of performing the method of FIGS. 5 and 6A.

FIG. 7 is a flow diagram showing a method of operation in a processor-based system to control operation of one or more robots in a multi-robot environment, according to at least one illustrated implementation, executable as part of performing the methods of FIG. 5, 6A or 6B.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, robots, actuator systems, and/or communications networks have not been shown or described in detail to avoid unnecessarily obscuring descriptions of the embodiments. In other instances, well-known computer vision methods and techniques for generating perception data and volumetric representations of one or more objects and the like have not been described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” or to “one embodiment” or “an embodiment” means that a particular feature, structure or characteristic described in connection with the embodiment is included in at least one implementation or in at least one implementation embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the terms determine, determining and determined when used in the context of whether a collision will occur or result, mean that an assessment or prediction is made as to whether a given pose or movement between two poses via a number of intermediate poses will or may result in a collision between a portion of a robot and some object (e.g., another portion of the robot, a portion of another robot, a persistent obstacle, a transient obstacle, for instance a person).

As used in this specification and the appended claims, the term robot refers to a machine that is capable of carrying out a complex series of actions either autonomously or semi-autonomously. Robots can take the form of a robot with a base, a robotic appendage movable coupled to the base, and an end effector or end-of-arm implement carried by the robotic appendage, along with one or more actuators to drive the movement thereof. Such robots may or may not resemble humans. Robots can alternatively or additionally take the form of vehicles (e.g., autonomous or semi-autonomous vehicles).

As used in this specification and the appended claims, the terms “first”, “second”, “third” and so forth are used in a relative sense rather than in an absolute sense. Hence the term “first motion plan” refers to a motion plan that is to be executed by a given robot before a “second motion plan” even though the “first motion plan” may not be the absolute first motion plan executed by the given robot. Likewise, the terms “first goal” and “first end pose” refer to a goal or end pose that occurs before a next or subsequent goal or a next or subsequent end pose, for instance before a “second goal” or “second end pose”, respectively. Further, the term “subsequent motion plan” refers to a motion plan to be executed by a given subsequently to a “preceding motion plan.” When used with reference to a robot, the terms “first robot”, “second robot”, and “third robot” are used simply to distinguish between two or more different robots operating in a shared workspace, the “first robot” in the various examples typically being the robot which is the object of the particular instance of motion planning. Likewise, the term “given robot” is used to refer to a robot for which the motion planning is being performed (the object of the particular instance of motion planning) while the terms “other robot” or “other robots” are used to refer to robots in the shared workspace other than the “given robot.”

As used in this specification and the appended claims, the terms “viable path” or “viable paths” refer to a path or paths that is or are complete from a start or current node to a goal node, where the nodes of each successive pairs of nodes in the path or paths are coupled by a respective edge that represents a valid transition between two configurations or poses that are represented by the respective nodes. As used in this specification and the appended claims, the terms “suitable path” or “suitable paths” refer to one or more viable paths that satisfy one or more conditions or constraints, for example that have an associated cost or cost function below a threshold cost or acceptable cost. As used in this specification and the appended claims, the term “selected path” refers to a viable path that has been selected from a set of viable paths or a set of suitable paths based on one or more criteria (e.g., selected based on cost or cost function, e.g. low cost or low cost function). As used in this specification and the appended claims, the term “least cost path” refers to a viable path that has a least cost of the viable paths in a set of viable paths or in a set of suitable paths. It is noted that a cost or cost function can represent an assessment of the risk or probability of collision, a severity of collision, an expenditure or consumption of energy and/or a time or latency associated with the viable path.

As used in this specification and the appended claims, the terms “blocked” or “likely blocked” mean that a given robot is prevented or at least delayed or will likely be prevented or will likely at least be delayed in executing a motion plan (e.g., a subsequent or second motion plan) by an obstacle, for example by another robot. In such instances, the given robot can become trapped, that is prevented or at least delayed from executing the subsequent motion plan until a new, revised or replacement motion plan is generated for the given robot and/or until the obstacle (e.g., another robot) is moved so as to no longer block or likely block the given robot in moving along a trajectory defined by the motion plan (e.g., a subsequent or second motion plan). In some instances, a given robot can even become deadlocked, unable to move or transition from a particular pose along any path or trajectory at least until the obstacle (e.g., another robot) is moved so as to no longer block or likely block the given robot. The delay can be any delay (e.g., any amount of delay other than no delay in the ability to execute a subsequent or second motion plan once commanded to execute such) or the delay can be a delay longer than a specified or threshold duration of delay (e.g., a specified non-zero amount of delay in the ability to execute a subsequent or second motion plan once commanded to execute such).

The headings and Abstract of the Disclosure provided herein are for convenience only and do not interpret the scope or meaning of the embodiments.

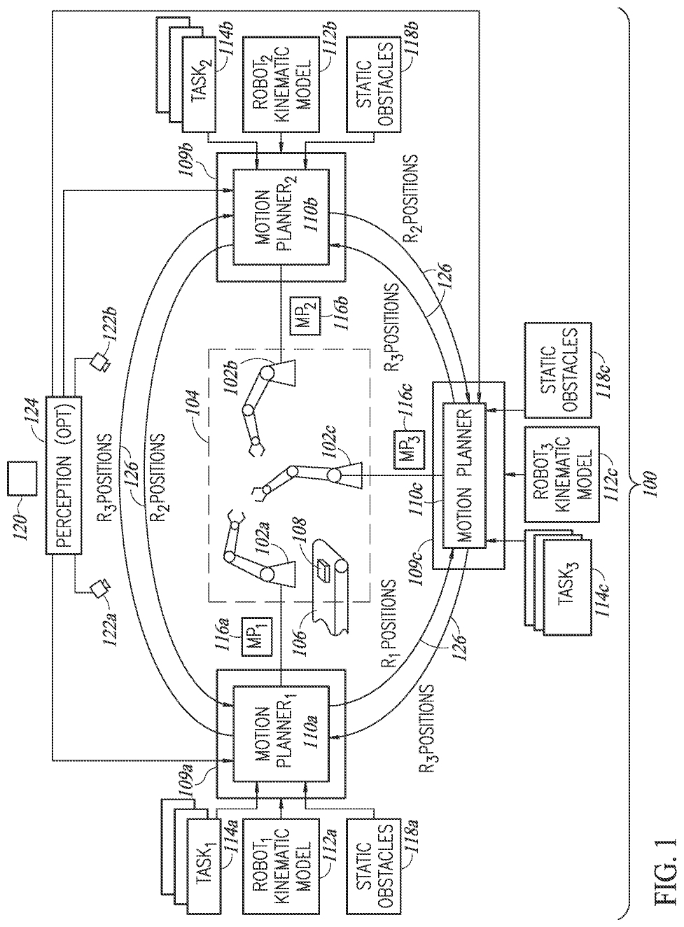

FIG. 1 shows a robotic system 100 which includes a plurality of robots 102a, 102b, 102c (collectively robots 102) that operate in a shared workspace 104 to carry out tasks employing look ahead motion planning to better position a robot when a subsequent trajectory or path of the robot is or likely will be blocked, for example blocked by another robot, and/or where a suitable and unblocked subsequent trajectory or path cannot not be found, according to one illustrated implementation. Such can improve robot operation in a variety of ways, for example reducing overall time to complete tasks, allowing completion of tasks that otherwise could not be completed, reducing overall energy usage, reducing the occurrence of collisions, and/or reducing consumption of computational resources.

The robots 102 can take any of a large variety of forms. Typically, the robots will take the form of, or have, one or more robotic appendages. The robots 102 may include one or more linkages with one or more joints, and actuators (e.g., electric motors, stepper motors, solenoids, pneumatic actuators or hydraulic actuators) coupled and operable to move the linkages in response to control or drive signals. Pneumatic actuators may, for example, include one or more pistons, cylinders, valves, reservoirs of gas, and/or pressure sources (e.g., compressor, blower). Hydraulic actuators may, for example, include one or more pistons, cylinders, valves, reservoirs of fluid (e.g., low compressibility hydraulic fluid), and/or pressure sources (e.g., compressor, blower). The robotic system 100 may employ other forms of robots 102, for example autonomous or semi-autonomous vehicles.

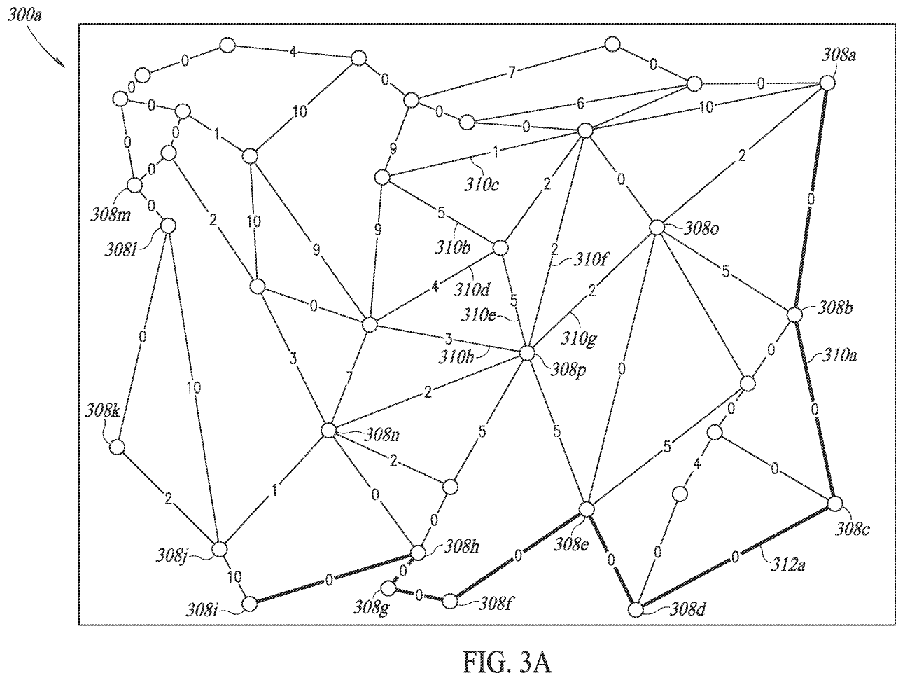

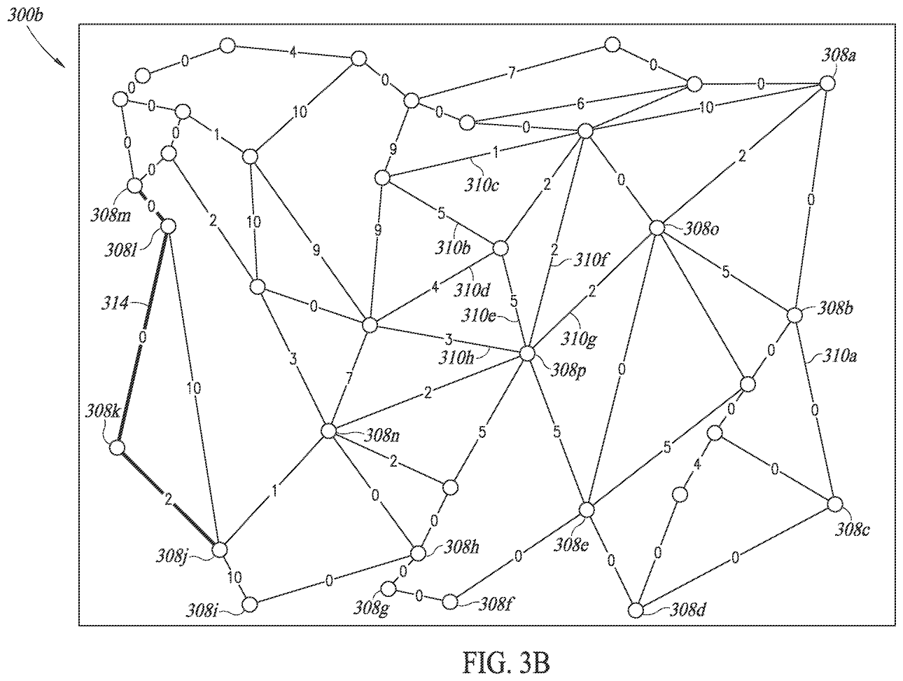

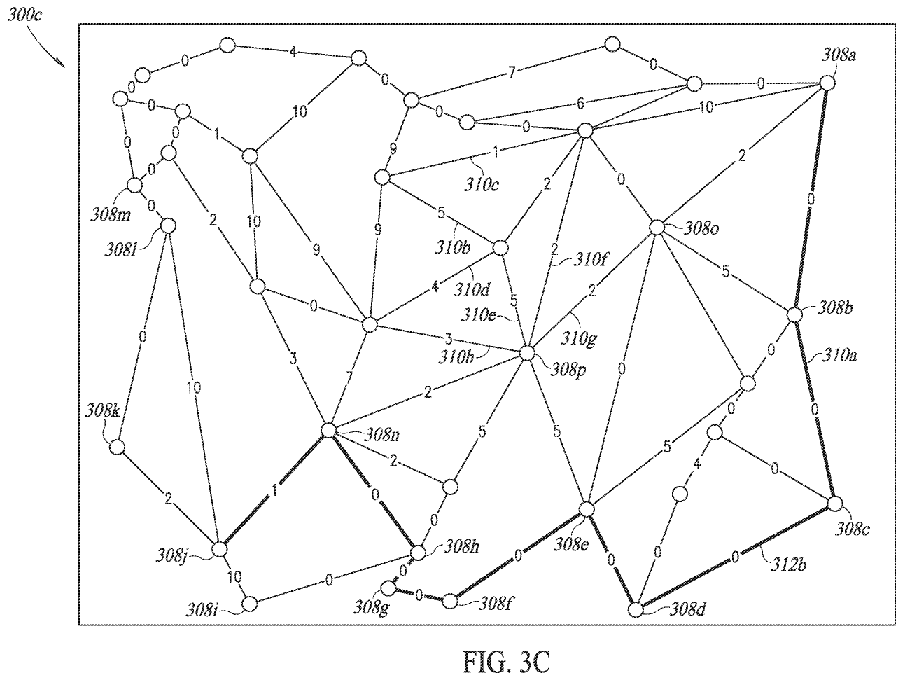

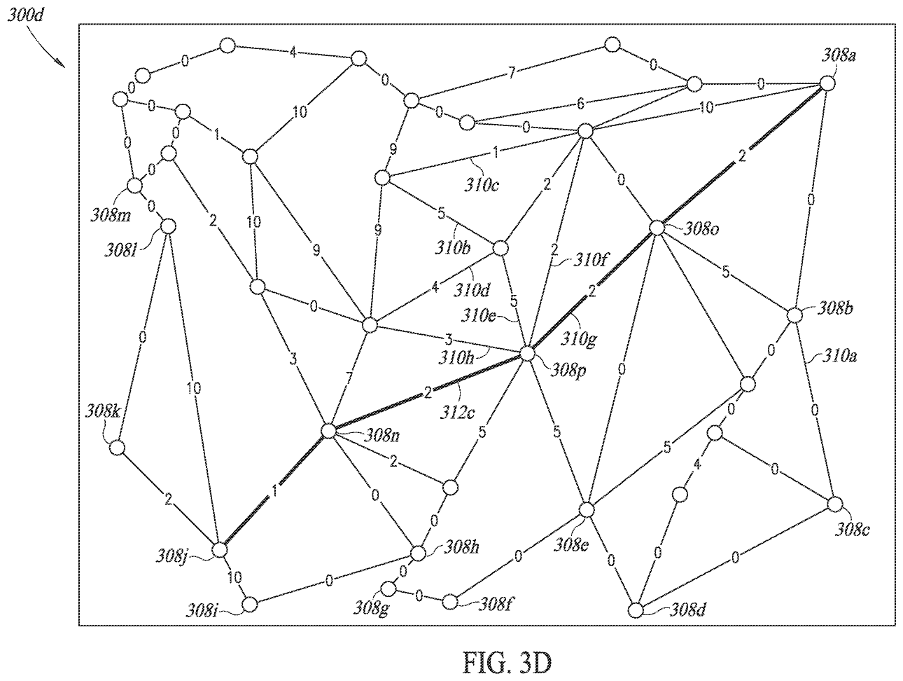

The shared workspace 104 typically represents a three-dimensional space in which the robots 102a-102c may operate and move, although in certain limited implementations the shared workspace 104 may represent a two-dimensional space. The shared workspace 104 is a volume or area in which at least portions of the robots 102 may overlap in space and time or otherwise collide if motion is not controlled to avoid collision. It is noted that the workspace 104 is different than a respective “configuration space” or “C-space” of the robot 102a-102c, which is described below, for example with reference to FIGS. 3A-3D.

As explained herein, a robot 102a or portion thereof may constitute an obstacle when considered from a viewpoint of another robot 102b (i.e., when motion planning for another robot 102b). The shared workspace 104 may additionally include other obstacles, for example pieces of machinery (e.g., conveyor 106), posts, pillars, walls, ceiling, floor, tables, humans, and/or animals. The shared workspace 104 may additionally include one or more work items or work pieces 108 which the robots 102 manipulate as part of performing tasks, for example one or more parcels, packaging, fasteners, tools, items or other objects.

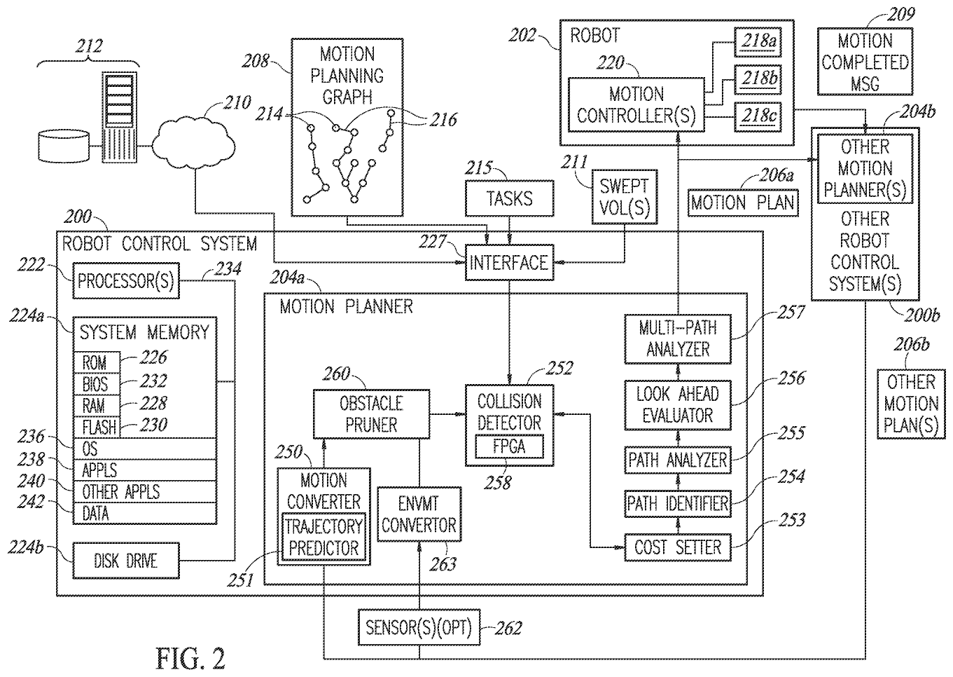

The robotic system 100 may include one or more robot control systems 109a, 109b, 109c, (three shown, collectively robot control systems 109) which include one or more motion planners, for example a respective motion planner 110a, 110b, 110c (three shown, collectively motion planners 110) for each of the robots 102a, 102b, 102c, respectively. In at least some implementations, a single motion planner 110 may be employed to generate motion plans for two, more, or all robots 102. The motion planners 110 are communicatively coupled to control respective ones of the robots 102. The motion planners 110 are also communicatively coupled to receive various types of input, for example including robot kinematic models 112a, 112b, 112c (collectively kinematic models 112) and/or task messages 114a, 114b, 114c. The motion planners 110 are optionally communicatively coupled (not illustrated in FIG. 1) to receive motion plans or other representations of motions 116a, 116b, 116c (collectively 116) for the other robots 102 operating in the shared workspace 104. The robot kinematic models 112 define a geometry of a given robot 102, for example in terms of joints, degrees of freedom, dimensions (e.g., length of linkages), and/or in terms of the respective C-space of the robot 102. (As illustrated in FIG. 2, the conversion of robot kinematic models 112 to motion planning graphs may occur during a configuration time that occurs before runtime of the robot or before task execution by the robot, performed for example by a processor-based system that is distinct and separate from the robotic system 100 using any of a variety of techniques.) The task messages 114a-114c specify tasks to be performed, for example in terms of goals (e.g., goal locations, goal poses or end poses, goal configurations or goal states and/or end configurations or end states). The performance of tasks can also involve the transition or movement through a number of intermediate poses, intermediate configurations or intermediate states of the respective robot 102. Poses, configurations or states may, for example, be defined in a configuration space (C-space) of the robot, for instance in terms of joint positions and joint angles/rotations (e.g., joint poses, joint coordinates) of the respective robot 102. Goal locations can be specified in real world coordinates (e.g., 2-space or two dimensional space or 3-space or three-dimensional space) of a workspace or alternatively specified in terms of C-space. The terms goal or goals typically refer to a location or region or area in which a robot or portion thereof is positioned to perform or execute a task and from which the task can be executed or performed by the robot. In this respect it is noted that a location from which a robot is capable of performing a task is not necessarily limited to a single point in space or area, but rather can encompass a relatively large volume of space or area, and may not be uniform in dimensions along any given axis in a given coordinate system. As such, the terms goal, goals, goal location or goal locations are not necessarily limited to a single point in space or in a region but can encompass a volume, region or area, for instance a volume, region or area from which a robot can perform a defined task.

The motion planners 110 are optionally communicatively coupled to receive as input static object data 118a, 118b, 118c. The static object data 118a, 118b, 118c is representative (e.g., size, shape, position, space occupied) of static objects 118 in the workspace 104, which may, for instance, be known a priori. Static objects 118 may, for example, include one or more of fixed structures in the workspace, for instance posts, pillars, walls, ceiling, floor, conveyor 106. Since the robots 102 are operating in a shared workspace, the static objects 118 will typically be identical for each robot. Thus, in at least some implementations, the static object data 118a, 118b, 118c supplied to the motion planners 110 will be identical. In other implementations, the static object data 118a, 118b, 118c supplied to the motion planners 110 may differ for each robot, for example based on a position or orientation of the robot 102 in the environment or an environmental perspective of the robot 102. Additionally, as noted above, in some implementations, a single motion planner 110 may generate the motion plans for two or more robots 102.

The motion planners 110 are optionally communicatively coupled to receive as input perception data 120, for example provided by a perception subsystem 124. The perception data 120 is representative of static and/or dynamic objects in the workspace 104 that are not known a priori. The perception data 120 may be raw data as sensed via one or more sensors (e.g., cameras 122a, 122b) and/or as converted to digital representations of obstacles by the perception subsystem 124.

The optional perception subsystem 124 may include one or more processors, which may execute one or more machine-readable instructions that cause the perception subsystem 124 to generate a respective discretization of a representation of an environment in which the robots 102 will operate to execute tasks for various different scenarios.

The optional sensors (e.g., camera 122a, 122b) provide raw perception information (e.g., point cloud) to perception subsystem 124. The optional perception subsystem 124 may process the raw perception information, and resulting perception data may be provided as a point cloud, an occupancy grid, boxes (e.g., bounding boxes) or other geometric objects, or stream of voxels (i.e., a “voxel” is an equivalent to a 3D or volumetric pixel) that represent obstacles that are present in the environment. The representation of obstacles may optionally be stored in on-chip memory. The perception data 120 may represent which voxels or sub-volumes (e.g., boxes) are occupied in the environment at a current time (e.g., during run time). In some implementations, when representing either a robot or another obstacle in the environment, the respective surfaces of the robot or an obstacle (e.g., including other robots) may be represented as either voxels or meshes of polygons (often triangles). In some cases, it is advantageous to represent the objects instead as boxes (rectangular prisms, bounding boxes, hierarchical data structures, for instance octrees or sphere trees) or other geometric objects. Due to the fact that objects are not randomly shaped, there may be a significant amount of structure in how the voxels are organized; many voxels in an object are immediately next to each other in 3D space. Thus, representing objects as boxes may require far fewer bits (i.e., may require just the x, y, z Cartesian coordinates for two opposite corners of the box). Also, performing intersection tests for boxes is comparable in complexity to performing intersection tests for voxels.

At least some implementations may combine the outputs of multiple sensors and the sensors may provide a very fine granularity voxelization. However, in order for the motion planner to efficiently perform motion planning, coarser voxels (i.e., “processor voxels”) may be used to represent the environment and a volume in 3D space swept by the robot 102 or portion thereof when making transitions between various states, configurations or poses. Thus, the optional perception subsystem 124 may transform the output of the sensors (e.g., camera 122a, 122b) accordingly. At runtime, if the robot control system 200 determines any of the sensor voxels within a processor voxel is occupied, the robot control system 200 considers the processor voxel to be occupied and generates the occupancy grid accordingly.

Various communicative paths are illustrated in FIG. 1 as arrows. The communicative paths may for example take the form of one or more wired communications paths (e.g., electrical conductors, signal buses, or optical fiber) and/or one or more wireless communications paths (e.g., via RF or microwave radios and antennas, infrared transceivers). Notably, each of the motion planners 110a-110c can be communicatively coupled to one another, either directly or indirectly, to provide the motion plan for a respective one of the robots 102a-102c to the other ones of the motion planners 110a-110c. For example, the motion planners 110a-110c may be communicatively coupled to one another via a network infrastructure, for instance a non-proprietary network infrastructure (e.g., Ethernet network infrastructure) 126. Such may advantageously allow operation of robots from different manufacturers in a shared workspace.

The term “environment” is used to refer to a current workspace of a robot, which is a shared workspace where two or more robots operate in the same workspace. The environment may include obstacles and/or work pieces (i.e., items with which the robots are to interact or act on or act with). The term “task” is used to refer to a robotic task in which a robot transitions from a pose A to a goal pose B preferably without colliding with obstacles in its environment. The goal pose is a pose for the robot to perform the specified task, typically on an object, at a location referred to as the goal location or goal. The task may perhaps involve the grasping or un-grasping of an item, moving or dropping an item, rotating an item, or retrieving or placing an item. The transition from pose A to goal pose B may optionally include transitioning between one or more intermediary poses. The term “scenario” is used to refer to a class of environment/task pairs. For example, a scenario could be “pick-and-place tasks in an environment with a 3-foot table or conveyor and between x and y obstacles with sizes and shapes in a given range.” There may be many different task/environment pairs that fit into such criteria, depending on the locations of goals and the sizes and shapes of obstacles.

The motion planners 110 are operable to dynamically produce motion plans 116 to cause the robots 102 to carry out tasks in an environment, while taking into account the planned motions (e.g., as represented by respective motion plans 116 or resulting swept volumes) of the other ones of the robots 102. The motion planners 110 may optionally take into account representations of a priori static objects 118 represented by static object data 118a, 118b, 118c and/or perception data 120 when producing motion plans 116. The motion planners 110 may advantageously take into account a known or a predicted location, pose and/or state of motion of other robots 102 at a given time, for instance whether or not another robot 102 has completed a given motion or task, and allowing a recalculation of a motion plan based on a motion or task of one of the other robots being completed, for instance making available a previously excluded path or trajectory to choose from.

As described herein, the motion planners 110 employ look ahead motion planning to facilitate the efficient operation of two or more robots operating in a shared workspace or workcell, preventing or at least reducing the risk that robots or robotic appendages of robots will collide with one another while efficiently moving one or more of the robots respectively to one or more goals to perform respective tasks in the shared workspace. The motion planners 110 can, for example, identify (e.g., select, generate) a first motion plan for a first robot that specifies a plurality of poses to transition the first robot from one pose to a first goal and a corresponding first end pose, the first end pose which locates at least a portion of the first robot at the first goal, and identify (e.g., select, generate) a second motion plan for the first robot that specifies a plurality of poses to transition the first robot from the first end pose to a second goal and a corresponding second end pose, the second end pose which locates at least a portion of the first robot at the second goal. The second motion plan can be determined before the first robot executes the first motion plan. The motion planners 110 can, for example, take into account how the first motion plan will affect the ability of the first robot to execute a subsequent second motion plan (e.g., second motion plan). For example, motion planners 110 can, for example, determine that a first motion plan will place the first robot in a first end pose from which it is impossible or difficult to execute the subsequent motion plan. For instance, another robot (e.g., a second robot) may block or may likely block the first robot from moving from the first end pose per the subsequent motion plan, for instance trapping, deadlocking or at least delaying the first robot in executing the second motion plan. One or more remedial actions may result from such, as described elsewhere herein, for example generation of a new or revised or replacement first motion plan to place the first robot or a portion thereof at the first goal but in a better end pose than the first end pose in the first motion plan. Such can, for example, be performed during a runtime of the robot(s). The new or revised or replacement first motion plan can be identified using various heuristics to efficiently position or configure the robot to complete its task. The system can monitor the other robots and cause the robot to move toward a goal in response to a suitable path becoming unblocked or cleared or otherwise found.

Optionally, the motion planners 110 may take into account an operational condition of the robots 102, for instance an occurrence or detection of a blocked trajectory or path or predicted blocked trajectory or path and/or an occurrence or detection of a situation in which a suitable and unblocked trajectory or path cannot not be found.

FIG. 2 shows an environment in which a first robot control system 200 includes a first motion planner 204a, that generates first motion plans 206a to control operation of a first robot 202, and which optionally provides the first motion plans 206a and/or representations of motions as obstacles to other motion planners 204b of other robot control systems 200b via at least one communications channel (indicated by proximate arrows, e.g., transmitter, receiver, transceiver, radio, router, Ethernet) to control other robots (not illustrated in FIG. 2), according to one illustrated implementation.

Likewise, the other motion planners 204b of the other robot control systems 200b generate other motion plans 206b to control operation of other robots (not illustrated in FIG. 2), and optionally provide the other motion plans 206b to the first motion planner 204a and other ones of the other motion planners 204b of other robot control systems 200b. The motion planners 204a, 204b may also optionally receive motion completed messages 209, which indicate when motions of various robots 202 have been completed. This may allow the motion planners 204a, 204b to generate new or updated motion plans based on a current or updated status of the environment. For example, a portion of a shared workspace may become unblocked or otherwise made available for a second robot to perform a task in, after a first robot 202 has completed a motion that is part or all of a set of motions to be formed as part of completing a task by the first robot. Additionally or alternatively, the motion planner 204a can receive information (e.g., images, occupancy grids, joint positions and joint angles/rotations) collected by various sensors or generated by the other motion planners 204b, which are indicative of when a portion of a shared workspace may become unblocked or otherwise made available for a second robot to perform a task in, after a first robot 202 has completed a motion that is part or all of a set of motions to be formed as part of completing a task by the first robot.

The robot control system(s) 200 may be communicatively coupled, for example via at least one communications channel (indicated by proximate arrows, e.g., transmitter, receiver, transceiver, radio, router, Ethernet), to receive motion planning graphs 208 and/or swept volume representations 211 from one or more sources 212 of motion planning graphs 208 and/or swept volume representations 211. The source(s) 212 of motion planning graphs 208 and/or swept volumes representations 211 may be separate and distinct from the motion planners 204a, 204b, according to one illustrated implementation. The source(s) 212 of motion planning graphs 208 and/or swept volumes representations 211 may, for example, be one or more processor-based computing systems (e.g., server computers), which may be operated or controlled by respective manufacturers of the robots 202 or by some other entity. The motion planning graphs 208 may each include a set of nodes 214 (only two called out in FIG. 2) which represent states, configurations or poses of the respective robot, and a set of edges 216 (only two called out in FIG. 2) which couple nodes 214 of respective pairs of nodes 214, and which represent legal or valid transitions between the states, configurations or poses. States, configurations or poses may, for example, represent sets of joint positions, orientations, poses, or coordinates for each of the joints of the respective robot 202. Thus, each node 214 may represent a pose of a robot 202 or portion thereof as completely defined by the poses of the joints comprising the robot 202. The motion planning graphs 208 may be determined, set up, or defined prior to a runtime (i.e., defined prior to performance of tasks), for example during a pre-runtime or configuration time. The swept volumes representations 211 represent respective volumes that a robot 202 or portion thereof would occupy when executing a motion or transition that corresponds to a respective edge 216 of the motion planning graph 208. The swept volumes representations 211 may be represented in any of a variety of forms, for example as voxels, a Euclidean distance field, a hierarchy of geometric objects. This advantageously permits some of the most computationally intensive work to be performed before runtime, when responsiveness is not a particular concern.

Each robot 202 may optionally include a base (not shown in FIG. 2). The base may be fixed in the environment or moveable therein (e.g., autonomous or semi-autonomous vehicle) Each robot 202 may optionally include a set of links, joints, end-of-arm tools or end effectors, and/or actuators 218a, 218b, 218c (three, shown, collectively 218) operable to move the links about the joints. The set of links, joints, end-of-arm tools or end effectors typically comprise one or more appendages of the robot, which robotic appendages can be moveably coupled to the base of the robot. Each robot 202 may optionally include one or more motion controllers (e.g., motor controllers) 220 (only one shown) that receive control signals, for instance in the form of motion plans 206a, and that provides drive signals to drive the actuators 218. Alternatively, the motion controllers 220 can be separate from, and communicatively coupled to, the robots 202.

There may be a respective robot control system 200 for each robot 202, or alternatively one robot control system 200 may perform the motion planning for two or more robots 202. One robot control system 200 will be described in detail for illustrative purposes. Those of skill in the art will recognize that the description can be applied to similar or even identical additional instances of other robot control systems 200.

The robot control system 200 may comprise one or more processor(s) 222, and one or more associated nontransitory computer- or processor-readable storage media for example system memory 224a, disk drives 224b, and/or memory or registers (not shown) of the processors 222. The nontransitory computer- or processor-readable storage media (e.g., system memory 224a, drive(s) 224b) are communicatively coupled to the processor(s) 222a via one or more communications channels, such as system bus 234. The system bus 234 can employ any known bus structures or architectures, including a memory bus with memory controller, a peripheral bus, and/or a local bus. One or more of such components may also, or instead, be in communication with each other via one or more other communications channels, for example, one or more parallel cables, serial cables, or wireless network channels capable of high speed communications, for instance, Universal Serial Bus (“USB”) 3.0, Peripheral Component Interconnect Express (PCIe) or via Thunderbolt®.

The robot control system 200 may also be communicably coupled to one or more remote computer systems, e.g., server computer (e.g. source 212 of motion planning graphs), desktop computer, laptop computer, ultraportable computer, tablet computer, smartphone, wearable computer and/or sensors (not illustrated in FIG. 2), that are directly communicably coupled or indirectly communicably coupled to the various components of the robot control system 200, for example via a network interface 227. Remote computing systems (e.g., server computer (e.g., source 212 of motion planning graphs)) may be used to program, configure, control or otherwise interface with or input data (e.g., motion planning graphs 208, swept volumes representations 211, task specifications 215) to the robot control system 200 and various components within the robot control system 200. Such a connection may be through one or more communications channels, for example, one or more wide area networks (WANs), for instance, Ethernet, or the Internet, using Internet protocols. As noted above, pre-runtime calculations may be performed by a system that is separate from the robot control system 200 or robot 202, while runtime calculations may be performed by the processor(s) 222 of the robot control system 200, which in some implementations may be on-board the robot 202.

As noted, the robot control system 200 may include one or more processor(s) 222, (i.e., circuitry), nontransitory storage media (e.g., system memory 224a, drive(s) 224b), and system bus 234 that couples various system components. The processors 222 may be any logic processing unit, such as one or more central processing units (CPUs), digital signal processors (DSPs), graphics processing units (GPUs), field programmable gate arrays (FPGAs), application-specific integrated circuits (ASICs), programmable logic controllers (PLCs), etc. The system memory 224a may include read-only memory (“ROM”) 226, random access memory (“RAM”) 228, FLASH memory 230, EEPROM (not shown). A basic input/output system (“BIOS”) 232, which can form part of the ROM 226, contains basic routines that help transfer information between elements within the robot control system 200, such as during start-up.

The drive 224b may be, for example, a hard disk drive for reading from and writing to a magnetic disk, a solid state (e.g., flash memory) drive for reading from and writing to solid state memory, and/or an optical disk drive for reading from and writing to removable optical disks. The robot control system 200 may also include any combination of such drives in various different embodiments. The drive 224b may communicate with the processor(s) 222 via the system bus 234. The drive(s) 224b may include interfaces or controllers (not shown) coupled between such drives and the system bus 234, as is known by those skilled in the relevant art. The drive 224b and its associated computer-readable media provide nonvolatile storage of computer- or processor readable and/or executable instructions, data structures, program modules and other data for the robot control system 200. Those skilled in the relevant art will appreciate that other types of computer-readable media that can store data accessible by a computer may be employed, such as WORM drives, RAID drives, magnetic cassettes, digital video disks (“DVD”), Bernoulli cartridges, RAMs, ROMs, smart cards, etc.

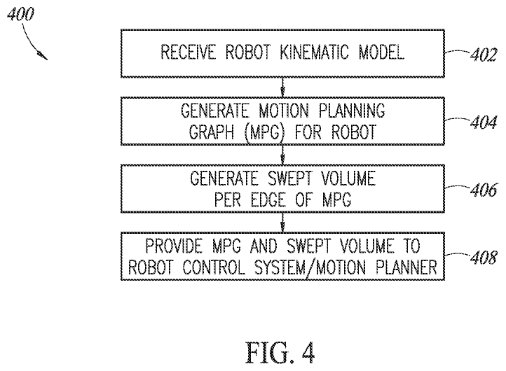

Executable instructions and data can be stored in the system memory 224a, for example an operating system 236, one or more application programs 238, other programs or modules 240 and program data 242. Application programs 238 may include processor-executable instructions that cause the processor(s) 222 to perform one or more of: generating discretized representations of the environment in which the robot 202 will operate, including obstacles and/or target objects or work pieces in the environment where planned motions of other robots may be represented as obstacles; generating motion plans including calling for or otherwise obtaining results of a collision assessment, setting cost values for edges in a motion planning graph, and evaluating available paths in the motion planning graph; identifying (e.g., selecting, generating) viable paths and/or motion plans, optionally storing the determined motion plans, and/or providing instructions to cause one or more robots to move per the motion plans. The motion planning and motion plan construction (e.g., collision detection or assessment, updating costs of edges in motion planning graphs based on collision detection or assessment, and path search or evaluation including identification of viable paths, assessment of viable paths for suitable paths, and optionally selection of a selected path from the viable or suitable paths) can be executed as described herein (e.g., with reference to FIGS. 4, 5, 6A, 6B and 7) and in the references incorporated herein by reference. The collision detection or assessment may perform collision detection or assessment using various structures and techniques described elsewhere herein. Application programs 238 may also include one or more machine-readable and machine-executable instructions that cause the processor(s) 222 to monitor the robots in the environment to determine when a trajectory or path (e.g., viable path) becomes unblocked or cleared, and to cause the robot to move toward a goal in response to the trajectory or path becoming unblocked or cleared. Application programs 238 may additionally include one or more machine-readable and machine-executable instructions that cause the processor(s) 222 to perform other operations, for instance optionally handling perception data (captured via sensors). Application programs 238 may additionally include one or more machine-executable instructions that cause the processor(s) 222 to perform various other methods described herein and in the references incorporated herein by reference.

In various embodiments, one or more of the operations described above may be performed by one or more remote processing devices or computers, which are linked through a communications network (e.g., network 210) via network interface 227.

While shown in FIG. 2 as being stored in the system memory 224a, the operating system 236, application programs 238, other programs/modules 240, and program data 242 can be stored on other nontransitory computer- or processor-readable media, for example drive(s) 224b.

The motion planner 204 of the robot control system 200 may include dedicated motion planner hardware or may be implemented, in all or in part, via the processor(s) 222 and processor-executable instructions stored in the system memory 224a and/or drive 224b.

The motion planner 204 may include or implement a motion converter 250, a collision detector 252, a cost setter 253, path finder 254, a path analyzer 255; a look ahead evaluator 256, and optionally a multi-path analyzer 257. Each of these can be implemented via one or more processors (e.g., circuitry) executing logic (e.g., executable software or firmware instructions, or hardwired logic). The motion converter 250 converts motions of other ones of the robots into representations of obstacles. The motion converter 250 receives the motion plans 204b or other representations of motion from other motion planners 204b.

The motion converter 250 can include a trajectory predictor 251 to predict trajectories of transient objects (e.g., other robots, other objects including, for instance people), for example where the trajectory of the transient objects is not known (e.g., where the object is another robot but no motion plan for that other robot has been received, where the object is not another robot, for instance a human). The trajectory predictor 251 can, for example, assume that an object will continue an existing motion in both direction, speed and acceleration, with no changes. The trajectory predictor 251 can, for example, account for expected changes in a motion or path of an object, for example where the path of the object will result in a collision, thus the object can be expected to stop or change direction, or where a goal of the object is known, thus the object can be expected to stop upon reaching the goal. The trajectory predictor 251 can, in at least some instances, employ learned behavioral models of the object to predict the trajectory of the object.

The motion converter 250 then determines an area or volume corresponding to the motion(s). For example, the motion converter can convert the motion to a corresponding swept volume, that is a volume swept by the corresponding robot or portion thereof in moving or transitioning between poses as represented by the motion plan. Advantageously, the motion converter 250 may simply queue the obstacles (e.g., swept volumes), and may not need to determine, track or indicate a time for the corresponding motion or swept volume. While described as a motion converter 250 for a given robot 202 converting the motions of other robots 202b to obstacles, in some implementations the other robots 202b may provide the obstacle representation (e.g., swept volume) of a particular motion to the given robot 202.

The collision detector 252 performs collision detection or analysis, determining whether a transition or motion of a given robot 202 or portion thereof will result in a collision with an obstacle. As noted, the motions of other robots may advantageously be represented as obstacles. Thus, the collision detector 252 can determine whether a motion of one robot will result in collision with another robot that moves through the shared workspace.

In some implementations, collision detector 252 implements software based collision detection or assessment, for example performing a bounding box-bounding box collision assessment or assessing based on a hierarchy of geometric (e.g., spheres) representation of the volume swept by the robots 202, 202b or portions thereof during movement. In some implementations, the collision detector 252 implements hardware based collision detection or assessment, for example employing a set of dedicated hardware logic circuits to represent obstacles and streaming representations of motions through the dedicated hardware logic circuits. In hardware based collision detection or assessment, the collision detector can employ one or more configurable arrays of circuits, for example one or more FPGAs 258, and may optionally produce Boolean collision assessments.

The cost setter 253 can set or adjust a cost of edges in a motion planning graph, based at least in part on the collision detection or assessment. For example, the cost setter 253 can set a relatively high cost value for edges that represent transitions between states or motions between poses that result or would likely result in collision. Also for example, the cost setter 253 can set a relatively low cost value for edges that represent transitions between states or motions between poses that do not result or would likely not result in collision. Setting cost can include setting a cost value that is logically associated with a corresponding edge via some data structure (e.g., field, pointer, table).

The path identifier 254 can determine or identify one or more viable paths from a starting node to a goal node. For example, the path identifier 254 can determine or identify sets of nodes in a motion planning graph that provide a complete path from a starting or current node to a goal node, i.e., a set of nodes for which each of pair of successive nodes in the complete path has a respective valid transition therebetween as represented by the existence of an edge coupling the nodes of the pair of nodes. The path identifier 254 can use or execute any variety of path finding algorithms. In some implementations, the path identifier 254 can determine or identify viable paths independent of cost, creating a set of viable path. In other instances, the path identifier 254 can take cost into account when determining or identifying viable paths.

The optional path analyzer 255 can determine or identify one or more suitable paths and/or select a single path (i.e., selected path, e.g., an optimal or optimized path) using the motion planning graph with the cost values. The path analyzer 255 can, for instance identify one or more paths that meet some specified criteria (e.g., cost within a threshold upper limit) or even select a single path from the set of viable paths determined or identified by the path identifier 254 (e.g., select a lowest cost path). The path analyzer 255 can, for example, constitute a least cost path optimizer that determines a lowest or relatively low cost path between two states, configurations or poses, the states, configurations or poses which are represented by respective nodes in the motion planning graph. The path analyzer 255 can use or execute any variety of path finding algorithms, for example lowest cost path finding algorithms, taking into account cost values associated with each edge which represent likelihood of collision and optionally represent one or more of: a severity of collision, an expenditure or consumption of energy and/or of time or latency to execute or complete.

Various algorithms and structures to determine the least cost path may be used, including those that implement the Bellman-Ford algorithm, but others may be used, including, but not limited to, any such process in which the least cost path is determined as the path between two nodes in the motion planning graph 208 such that the sum of the costs or weights of its constituent edges is minimized. This process improves the technology of motion planning for a robot 102, 202 by using a motion planning graph which represents motions of other robots as obstacles and collision detection to increase the efficiency and response time to find the “best” path to perform a task without collisions.

The look ahead evaluator 256 can evaluate whether an end pose (e.g., first end pose) that would result from execution of a preceding motion plan (e.g., a first motion plan) will be disadvantageous to execution of a subsequent motion plan (e.g., second motion plan), and cause a remedial action to be taken if the end pose (e.g., first end pose) would be disadvantageous. The look ahead evaluator 256 can, for example, determine whether execution of the preceding motion plan (e.g., first motion plan) by a given robot will result in the given robot being placed into a pose (e.g., a pose at a first goal) that will cause the given robot to subsequently be trapped or even deadlocked (e.g., blocked or likely blocked, for instance by another robot) when executing or attempting to execute a subsequent motion plan (e.g., second motion plan). The look ahead evaluator 256 can, for example, determine whether execution of the preceding motion plan (e.g., first motion plan) by a given robot will cause the given robot to subsequently be or likely blocked with a probability above some defined threshold (e.g., blocked by another robot) when executing or attempting to execute a subsequent motion plan (e.g., second motion plan). The look ahead evaluator 256 can, for example, determine whether execution of the preceding motion plan (e.g., first motion plan) by a given robot will cause it to be difficult to generate a subsequent motion plan or a subsequent motion plan with an acceptable probability of being collision free (e.g., probability equal to or above a defined probability of being collision free, or a probability being below a defined probability of experiencing a collision). The look ahead evaluator 256 can, for example, determine whether execution of the preceding motion plan (e.g., first motion plan) by a given robot will cause or a delay or an unacceptably long delay in execution of a subsequent motion plan due to the given robot being blocked or likely blocked from transitioning between the first and the subsequent motion plan. The look ahead evaluator 256 can, for example, compare respective delays associated with two or more different motion plans, and determine whether any of the motion plans is acceptable (e.g., has an associated delay below a defined delay threshold) and/or decide whether additional motion plans should be generated in an attempt to find a motion plan with an acceptably small amount of delay.

The look ahead evaluator 256 can cause a remedial action to be taken, for example in response to a determination of the existence or presence of a blocking or likely blocking condition or a determination that a blocking or likely blocking position will occur if a given robot and/or other robot moves along a respective trajectory. In at least some implementations, the look ahead evaluator 256 can determine or select a type of remedial action to be taken, for example selecting from a set of different types of remedial actions based on one or more criteria. As described herein, one or more of various types of remedial actions can be implemented. For example, a new, revised or replacement first motion plan can be generated to move a given robot to a first goal based on analysis of a second motion plan that moves the given robot from the first goal. Also for example, a new, revised or replacement motion plan can be generated for another robot that is blocking or will likely block the given robot. Also for example, a new order of a set of goals can be determined or generated, the set of goals including the first goal and at least the second goal. Such can be determined or generated pseudo-randomly or based on one or more heuristics (e.g., always try to move the first goal one position downstream relative to the order of the set of goals which is being modified).

The optional multi-path analyzer 257 can analyze a total or aggregate cost associated with two or more motion plans (e.g., aggregate cost of the first motion plan and the second motion plan). Such can be used to identify the combination of motion plans with the overall lowest cost. The multi-path analyzer 257 can, for example, consider the total or aggregate cost of the two or more options for the first motion plan in conjunction with a second motion plan. Such is not limited to only two levels of motion planning depth, but could take into account additional levels of motion planning (e.g., a third motion plan to transition from the second goal to a third goal). The multi-path analyzer 257 can constitute a least cost path optimizer that determines a lowest or relatively low cost combination of two or more paths between two states, configurations, poses or goals, the states, configurations, poses or goals (e.g., starting pose through first goal to second goal) which are represented by respective nodes in the motion planning graphs. The multi-path analyzer 257 can use or execute any variety of path finding algorithms, for example lowest cost path finding algorithms, taking into account cost values associated with each edge which cost values represent an associated likelihood of collision and optionally represent one or more of: a severity of collision, an expenditure or consumption of energy and/or of time or latency to execute or complete associated with the transition represented by the respective edge. In at least some implementations, the multi-path analyzer 257 can form part of the look ahead evaluator 256.

The motion planner 204a may optionally include a pruner 260. The pruner 260 may receive information that represents completion of motions by other robots, the information denominated herein as motion completed messages 209. Alternatively, a flag could be set to indicate completion. In response, the pruner 260 may remove an obstacle or portion of an obstacle that represents the now completed motion. That may allow generation of a new motion plan for a given robot, which may be more efficient or allow the given robot to attend to performing a task that was otherwise previously prevented by the motion of another robot. This approach advantageously allows the motion converter 250 to ignore timing of motions when generating obstacle representations for motions, while still realizing better throughput than using other techniques. The motion planner 204a may additionally send a signal, prompt or trigger to cause the collision detector 252 to perform a new collision detection or assessment given the modification of the obstacles to produce an updated motion planning graph in which the edge weights or costs associated with edges have been modified, and to cause the cost setter 253, path identifier 254, path analyzer 255, look ahead evaluator 256 and optionally multi-path analyzer 257 to update cost values and determine a new or revised motion plan accordingly.

The motion planner 204a may optionally include an environment converter 263 that converts output (e.g., digitized representations of the environment) from optional sensors 262 (e.g., digital cameras) into representations of obstacles. Thus, the motion planner 204a can perform motion planning that takes into account transitory objects in the environment, for instance people, animals, etc.

The processor(s) 222 and/or the motion planner 204a may be, or may include, any logic processing units, such as one or more central processing units (CPUs), digital signal processors (DSPs), graphics processing units (GPUs), application-specific integrated circuits (ASICs), field programmable gate arrays (FPGAs), programmable logic controllers (PLCs), etc. Non-limiting examples of commercially available computer systems include, but are not limited to, the Celeron, Core, Core 2, Itanium, and Xeon families of microprocessors offered by Intel® Corporation, U.S.A.; the K8, K10, Bulldozer, and Bobcat series microprocessors offered by Advanced Micro Devices, U.S.A.; the A5, A6, and A7 series microprocessors offered by Apple Computer, U.S.A.; the Snapdragon series microprocessors offered by Qualcomm, Inc., U.S.A.; and the SPARC series microprocessors offered by Oracle Corp., U.S.A. The construction and operation of the various structure shown in FIG. 2 may implement or employ structures, techniques and algorithms described in or similar to those described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; International Patent Application Publication No. WO 2016/122840, filed Jan. 5, 2016, entitled “SPECIALIZED ROBOT MOTION PLANNING HARDWARE AND METHODS OF MAKING AND USING SAME”; and/or U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”.

Although not required, many of the implementations will be described in the general context of computer-executable instructions, such as program application modules, objects, or macros stored on computer- or processor-readable media and executed by one or more computer or processors that can perform obstacle representation, collision assessments, and other motion planning operations.

Motion planning operations may include, but are not limited to, generating or transforming one, more or all of: a representation of the robot geometry based on a kinematic model 112 (FIG. 1), tasks 114 (FIG. 1), and the representation of volumes (e.g. swept volumes) occupied by robots in various states or poses and/or during movement between states or poses into digital forms, e.g., point clouds, Euclidean distance fields, data structure formats (e.g., hierarchical formats, non-hierarchical formats), and/or curves (e.g., polynomial or spline representations). Motion planning operations may optionally include, but are not limited to, generating or transforming one, more or all of: a representation of the static or persistent obstacles or static objects 118 (FIG. 1) and/or the perception data 120 representative of static or transient obstacles 118 (FIG. 1) into digital forms, e.g., point clouds, Euclidean distance fields, data structure formats (e.g., hierarchical formats, non-hierarchical formats), and/or curves (e.g., polynomial or spline representations).

Motion planning operations may include, but are not limited to, determining or detecting or predicting collisions for various states or poses of the robot or motions of the robot between states or poses using various collision assessment techniques or algorithms (e.g., software based, hardware based).

In some implementations, motion planning operations may include, but are not limited to, determining one or more motion planning graphs, motion plans or road maps; storing the determined planning graph(s), motion plan(s) or road map(s), and/or providing the planning graph(s), motion plan(s) or road map(s) to control operation of a robot.

In one implementation, collision detection or assessment is performed in response to a function call or similar process, and returns a Boolean value thereto. The collision detector 252 may be implemented via one or more field programmable gate arrays (FPGAs) and/or one or more application specific integrated circuits (ASICs) to perform the collision detection while achieving low latency, relatively low power consumption, and increasing an amount of information that can be handled.

In various implementations, such operations may be performed entirely in hardware circuitry or as software stored in a memory storage, such as system memory 224a, and executed by one or more hardware processors 222a, such as one or more microprocessors, digital signal processors (DSPs), field programmable gate arrays (FPGAs), application specific integrated circuits (ASICs), graphics processing units (GPUs) processors, programmed logic controllers (PLCs), electrically programmable read only memories (EEPROMs), or as a combination of hardware circuitry and software stored in the memory storage.

Various aspects of perception, planning graph construction, collision detection, and path search that may be employed in whole or in part are also described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS,” International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”, and International Patent Application No. PCT/US2020/039193, filed Jun. 23, 2020, entitled “MOTION PLANNING FOR MULTIPLE ROBOTS IN SHARED WORKSPACE” and published as WO 2020/263861. Those skilled in the relevant art will appreciate that the illustrated implementations, as well as other implementations, can be practiced with other system structures and arrangements and/or other computing system structures and arrangements, including those of robots, hand-held devices, multiprocessor systems, microprocessor-based or programmable consumer electronics, personal computers (“PCs”), networked PCs, mini computers, mainframe computers, and the like. The implementations or embodiments or portions thereof (e.g., at configuration time and runtime) can be practiced in distributed computing environments where tasks or modules are performed by remote processing devices, which are linked through a communications network. In a distributed computing environment, program modules may be located in both local and remote memory storage devices or media. However, where and how certain types of information are stored is important to help improve motion planning.

For example, various motion planning solutions “bake in” a roadmap (i.e., a motion planning graph) into the processor (e.g., FPGA), and each edge in the roadmap corresponds to a non-reconfigurable Boolean circuit of the processor. The design in which the planning graph is “baked in” to the processor, poses a problem of having limited processor circuitry to store multiple or large planning graphs and is generally not reconfigurable for use with different robots.

One solution provides a reconfigurable design that places the planning graph information into memory storage. This approach stores information in memory instead of being baked into a circuit. Another approach employs templated reconfigurable circuits in lieu of memory.

As noted above, some of the information (e.g., robot geometric models) may be captured, received, input or provided during a configuration time, that is before run time. The received information may be processed during the configuration time to produce processed information (e.g., motion planning graphs) to speed up operation or reduce computation complexity during runtime.

During the runtime, collision detection may be performed for the entire environment, including determining, for any pose or movement between poses, whether any portion of the robot will collide or is predicted to collide with another portion of the robot itself, with other robots or portions thereof, with persistent or static obstacles in the environment, or with transient obstacles in the environment with unknown trajectories (e.g., people).

FIGS. 3A, 3B, 3C and 3D show example motion planning graphs 300a, 300b, 300c, 300d for the robot 102 (FIG. 1), 202 (FIG. 2) in the case where the goal of the robot 102, 202 is to perform a task while avoiding collisions with static obstacles and dynamic obstacles, the obstacles which can include other robots operating in a shared workspace.

In particular, the motion planning graph 300a (FIG. 3A) illustrates a first viable path 312a between a current node 308a representing a current pose and a first goal. In this example, the first goal can, for example, correspond to a node 308i representing a respective goal pose which positions a robot or portion thereof at the first goal. In this example, the first viable path 312a is comprised of the edges between nodes 308a, 308b, 308c, 308d, 308e, 308f, 308g, 308h, and 308i sequentially, and is illustrated in FIG. 3A with heavier line weight than the other edges in the motion planning graph 300a. For convenience of reference, the first viable path 312a can be denominated as a previous or first motion plan.

The motion planning graph 300b (FIG. 3B) illustrates a viable path 314 between the first goal and a second goal. In this example, the first goal can, for example, correspond to a node 308j representing a respective goal pose which positions a robot or portion thereof at the first goal. Notably, in at least in some circumstances there may be one, two, or even more poses that position a robot or portion thereof at a given goal. Hence, there can be one, two or even more nodes that position a robot or portion thereof at a given goal. Some poses may be more suitable for avoiding the robot being trapped or even deadlocked at a given goal. In this example, the second goal can correspond to a node 308m representing a respective pose which positions the robot or portion thereof at the second goal. In this example, the viable path 314 is comprised of the edges between nodes 308j, 308k, 308l, 308m, sequentially, and is illustrated in FIG. 3B with heavier line weight than the other edges in the motion planning graph 300b. For convenience of reference, the viable path 314 can be denominated as a subsequent or second motion plan, in that such is intended to be executed after the previous or first motion plan.

Notably, the edge directly coupling the node 308i at the end of the first viable path 312a to the node 308j in the second viable path 314 is associated with a relative high risk of collision. Such may, for example, represent a risk of the robot being trapped or even deadlock if the two viable paths are selected for motion plans. The look ahead motion planning described herein can take account of such, and can take remedial action. As noted above, in at least some motion planning situations, there may be more than one pose (e.g., two or more goal poses) which positions a robot or portion thereof at a given goal, allowing the robot to execute a task. Those poses (e.g., goal poses) are represented by respective nodes in the motion planning graph. In the current example, the pose associated with the node 308i and the pose associated with node 308j both locate the robot or portion thereof at the first goal. In this situation, one of the available remedial actions is to perform the motion planning again to determine a new, revised or replacement first motion plan that accommodates or accounts for the second motion plan. Two different new, revised or replacement first motion plans are illustrated in FIGS. 3C and 3D, respectively.

The motion planning graph 300c (FIG. 3C) illustrates one alternative for a new, revised or replacement first viable path 312b between the current node 308a representing the current pose and node 308j which positions the robot or portion thereof at the first goal. In this example, the new, revised or replacement first viable path 312b is comprised of the edges between nodes 308a, 308b, 308c, 308d, 308e, 308f, 308g, 308h, 308n, and 308j sequentially, and is illustrated in FIG. 3C with heavier line weight than the other edges in the motion planning graph 300c. For convenience of reference, the new, revised or replacement first viable path 312b can be denominated as a new, revised or replacement previous motion plan, in that such is intended to be executed before the subsequent or second motion plan. Notably, this motion plan can have a relatively low associated risk of collision (e.g., indicated by the aggregate values associated with the respective edges thereof, in this example the total is 1), although does include a relatively large number of poses (e.g., nine distinct poses in this example, although in many practical applications the number of distinct poses may be much larger).

The motion planning graph 300d (FIG. 3D) illustrates another alternative for a new, revised or replacement first viable path 312c between the current node 308a representing the current pose and a node 308j which positions the robot or portion thereof at the first goal. In this example, the new, revised or replacement first viable path 312c is comprised of the edges between nodes 308a, 308b, 308p, 308n, and 308j sequentially, and is illustrated in FIG. 3D with heavier line weight than the other edges in the motion planning graph 300d. For convenience of reference, the new, revised or replacement first viable path 312d can be denominated as a new, revised or replacement previous motion plan, in that such is intended to be executed before the subsequent or second motion plan. Notably, this motion plan may have a relatively higher associated risk of collision (e.g., indicated by the aggregate values associated with the respective edges thereof, in this example the total is 7) as compared to that of FIG. 3C, although does include a relatively small number of poses (e.g., five distinct poses in this example, although in many practical applications the number of distinct poses may be much larger) as compared to that of FIG. 3C. A smaller number of poses can, at least in some implementations, be associated with less latency and/or less expenditure of energy. Thus, in some implementations, a higher risk of collision can be consider a reasonable tradeoff for savings in latency and/or energy expenditure.

As used herein, the term viable path refers to a path that is complete from a start or current node to a goal node. The viable paths of a set of viable paths can be assessed to identify one or more suitable or even optimal viable path based at least in part on an associated cost or cost function of each viable path, and optionally on a threshold or acceptable cost. As explained herein, a cost or cost function can represent an assessment of the risk of collision, a severity of collision, an expenditure or consumption of energy and/or of time or latency associated with the viable path.

The motion planning graphs 300a, 300b, 300c, 300d each respectively comprise a plurality of nodes, represented in the drawing as open circles, connected by edges, represented in the drawing as straight lines between pairs of nodes. A subset of the nodes are called out as nodes 308a-308p, and a subset of the edges are called out as edges 310a-310h. Each node represents, implicitly or explicitly, time and variables that characterize a state of the robot 102, 202 in the configuration space of the robot 102, 202. The configuration space is often called C-space and is the space of the states or configurations or poses of the robot 102, 202 represented in the motion planning graph 300a, 300b, 300c, 300d. For example, each node may represent the state, configuration or pose of the robot 102, 202 which may include, but is not limited to, a position, orientation or pose (i.e., position and orientation). The state, configuration or pose may, for example, be represented by a set of joint positions and joint angles/rotations (e.g., joint poses, joint coordinates) for the joints of the robot 102, 202.

The edges in the motion planning graph 300a, 300b, 300c, 300d represent valid or allowed transitions between these states, configurations or poses of the robot 102, 202. The edges in the motion planning graph 300a, 300b, 300c, 300d do not represent actual movements in Cartesian coordinates (2-space or 3-space), but rather represent transitions between states, configurations or poses in C-space of the robot. Each edge of the motion planning graph 300a, 300b, 300c, 300d represents a transition of a robot 102, 202 between a respective pair of nodes. For example, edge 310a represents a transition of a robot 102, 202, between two nodes. In particular, edge 310a represents a transition between a state of the robot 102, 202 in a particular configuration associated with node 308b and a state of the robot 102, 202 in a particular configuration associated with node 308c. For example, robot 102, 202 may currently be in a particular configuration associated with node 308a. Although the nodes are shown at various distances from each other, this is for illustrative purposes only and this is no relation to any physical distance. There is no limitation on the number of nodes or edges in the motion planning graph 300a, 300b, 300c, 300d, however, the more nodes and edges that are used in the motion planning graph 300a, 300b, 300c, 300d, the more accurately and precisely the motion planner may be able to determine a suitable or even an optimal path according to one or more states, configurations or poses of the robot 102, 202 to carry out a task since there are more viable paths to select the least cost path from.

Each edge is assigned or associated with a cost value. The cost value may represent a collision assessment with respect to a motion that is represented by the corresponding edge. The cost value may additionally represent other information, for example an energy expenditure associated with the transition or a duration of time to complete an associated movement or transition or task.

Typically, it is desirable for robot 102, 202 to avoid certain obstacles, for example other robots in a shared workspace. In some situations, it may be desirable for robot 102, 202 to contact or come in close proximity to certain objects in the shared workspace, for example to grip or move an object or work piece. FIGS. 3A, 3C and 3D show a “first” motion planning graph 300a and a pair of “new” or “revised” or “alternative” “first” motion planning graphs 300c, 300d, respectively, used by a motion planner to identify a viable path 312a, 312b, 312c (indicated by bolded lines) for robot 102, 202 to move to a first goal. The viable path 312a, 312b, 312c is generated or selected to cause the robot 102, 202 to move to a first goal by moving through a number of “intermediate poses” while avoiding collisions with one or more obstacles. FIG. 3B shows a “second” motion planning graph 300b, used by a motion planner to identify a viable path 314 (indicated by bolded line) for robot 102, 202 to move to a second goal from a first goal. The goals are typically locations at which the robot 102, 202 carries out one or more specified tasks (e.g., picking and placing an object) and a goal pose is a pose of the robot for performing the specified task. As previously noted, two or more nodes can be associated with respective poses that each place the robot or portion thereof at a given goal (e.g., the two or more poses each placing the robot or portion thereof at a given physical location or within a given physical volume or region or space from which a task can be performed, e.g., in a physical location, volume or region or space in real world space). Thus, it can be possible to reach a given goal via two or more paths that have respective different goal nodes and hence different end or goal poses from one another.

Obstacles may be represented digitally, for example, as bounding boxes, oriented bounding boxes, curves (e.g., splines), Euclidean distance field, or hierarchy of geometric entities, whichever digital representation is most appropriate for the type of obstacle and type of collision detection that will be performed, which itself may depend on the specific hardware circuitry employed. In some implementations, the swept volumes in the roadmap for the primary agent (e.g., robot 102) are precomputed. Examples of collision assessment are described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; U.S. Patent Application 62/722,067, filed Aug. 23, 2018 entitled “COLLISION DETECTION USEFUL IN MOTION PLANNING FOR ROBOTICS”; and in International Patent Application Publication No. WO 2016/122840, filed Jan. 5, 2016, entitled “SPECIALIZED ROBOT MOTION PLANNING HARDWARE AND METHODS OF MAKING AND USING SAME.”

The motion planner 110a, 110b, 110c (FIG. 1), 204 (FIG. 2) or a portion thereof (e.g., collision detector 252, FIG. 2) determines or assesses a likelihood or probability that a pose (represented by a node) and/or motion or transition (represented by an edge) will result in a collision with an obstacle. In some instances, the determination results in a Boolean value, while in others the determination may be expressed as a probability.

For nodes in the motion planning graph 300a, 300b, 300c, 300d where there is a probability that direct transition between the nodes will cause a collision with an obstacle, the motion planner (e.g., cost setter 253, FIG. 2) assigns a cost value or weight to the edges of the planning graph 300a, 300b, 300c, 300d transitioning between those nodes (e.g., edges 310a, 310b, 310c, 310d, 310e, 310f, 310g, 310h) indicating the probability of a collision with the obstacle.

For example, the motion planner may, for each of a number of edges of the motion planning graph 300a, 300a, 300c, 300d that has a respective probability of a collision with an obstacle below a defined threshold probability of a collision, assign a cost value or weight with a value equal or close to zero. In the present example, the motion planner has assigned a cost value or weight of zero to those edges in the planning graph 300a, 300b, 300c, 300d which represent transitions or motions of the robot 102, 202 that do not have any or have very little probability of a collision with an obstacle. For each of a number of edges of the motion planning graph 300a, 300b, 300c, 300d with a respective probability of a collision with an obstacle in the environment above the defined threshold probability of a collision, the motion planner assigns a cost value or weight with a value substantially greater than zero. In the present example, the motion planner has assigned a cost value or weight of greater than zero to those edges in the motion planning graph 300a, 300b, 300c, 300d which have a relatively high probability of collision with an obstacle. The particular threshold used for the probability of collision may vary. For example, the threshold may be 40%, 50%, 60% or lower or higher probability of collision. Also, assigning a cost value or weight with a value greater than zero may include assigning a weight with a magnitude greater than zero that corresponds with the respective probability of a collision. For example, as shown in the motion planning graph 300a, 300b, 300c, 300d, the motion planner has assigned a relatively high cost value or weight of 10 to some edges that have a higher probability of collision, but has assigned a cost value or weight with a relatively lower magnitude of 0 to other edges, which the motion planner determined have a much lower probability of collision. In other implementations, the cost values or weights may present a binary choice between collision and no collision, there being only two cost values or weights to select from in assigning cost values or weights to the edges.

The motion planner (e.g., cost setter 253, FIG. 2) may assign, set or adjust cost values or weights of each edge based on factors or parameters (e.g., energy expenditure, overall duration of time to complete an associated movement, transition and/or task) in addition to being based on an associated probability of collision.

After the motion planner sets a cost value or weight representing a probability of collision of the robot 102, 202 with an obstacle based at least in part on the collision assessment, the motion planner (e.g., path identifier 254, path analyzer 255, FIG. 2) identifies or generates viable paths (e.g., feasible paths with valid transitions between a current or start node and a goal node), and optionally performs an optimization to identify (e.g., determine, select) a suitable path (e.g., a viable path that satisfies one or more conditions or thresholds) or even select a selected viable path 312a, 312b, 312c, 312d (e.g., an optimal viable path or a best viable path or best suitable viable path) in the resulting motion planning graph 300a, 300b, 300c, 300d that provides a motion plan for the robot 102, 202 as specified by the identified suitable or even optimal viable path 312a, 312b, 312c, 312d with no or a relatively low potential of a collision with obstacles including other robots operating in a shared workspace.

In one implementation, once all edge costs of the motion planning graph 300a, 300b, 300c, 300d have been assigned or set, the motion planner (e.g., path analyzer 255, FIG. 2) may perform a calculation to determine a least cost path to or toward a goal represented by a goal node 308i. For example, the path analyzer 255 (FIG. 2) may perform a least cost path algorithm from the current state of the robot 102, 202 represented by current node 308a in the motion planning graph 300a, 300b, 300c, 300d to possible states, configurations or poses. The least cost (closest to zero) path in the motion planning graph 300a, 300b, 300c, 300d is then selected by the motion planner. As explained above, cost may reflect not only probability of collision, but also other factors or parameters (e.g., energy expenditure, overall duration of time to complete associated movement, transition and/or task). In the example illustrated in FIGS. 3A and 3B, a current state, configuration or pose of the robot 102, 202 in the motion planning graph 300a, 300b is at node 308a, and a first goal state, configuration or pose of the robot 102, 202 that places at least a portion (e.g., end effector, end of arm tool) of the given robot at a goal to perform the given task is a node 308i. In FIG. 3A, a viable path between the current node 308a and the goal node 308i is depicted as viable path 312a (bolded line path comprising segments extending from node 308a through node 308i successively) in the motion planning graph 300a. In FIG. 3B, a viable path (e.g., revised) between the first goal node 308j and a second goal node 308m is depicted as viable path 314 (bolded line path comprising segments extending from node 308j through node 308m, with intermediary nodes 308k and 308l) in the motion planning graph 300b.

Although shown as a viable path 312a, 314, 312b, 312c in motion planning graphs 300a, 300b, 300c and 300d respectively, with many sharp turns, such turns do not represent corresponding physical turns in a route, but logical transitions between states, configurations or poses of the robot 102, 202. For example, each edge in the identified viable path 312a, 314, 312b, 312c may represent a state change with respect to physical configuration of the robot 102, 202 in the environment, but not necessarily a change in direction of the robot 102, 202 corresponding to the angles of the viable path 312a, 314, 312b, 312c shown in FIGS. 3A, 3B, 3C and 3D respectively.

FIG. 4 shows a method 400 of operation in a processor-based system to produce motion planning graphs and swept volumes, according to at least one illustrated implementation. The method 400 may be executed before a runtime, for example during a configuration time. The method 400 may be executed by a processor-based system (e.g., server computer) that is separate and distinct, and possibly remote, from one or more robots and/or one or more robot control systems.

Motion planning graphs take significant time and resources to build, but as described herein, one would only have to do that once, for example, during a configuration time that occurs prior to runtime. Once generated, the motion planning graphs may be stored, for instance stored in a planning graph edge information memory or other nontransitory computer- or processor-readable medium, and it is relatively quick and efficient for the processor to swap the motion planning graphs in and out, or select which motion planning graph to use, for instance based on a current characteristic of a robot (e.g., such as when the robot is grasping an object of a particular size).

As noted above, some pre-processing activities may be performed before runtime and thus, in some implementations, these operations may be performed by remote processing devices, which are linked through a communications network to a robot control system via network interface. For example, a pre-runtime programming or configuration phase allows preparation of the robot for a problem of interest. In such implementations, extensive preprocessing is leveraged to avoid runtime computation. Preprocessing can, for example, include generating precomputed data (i.e., computed before runtime of the robot) regarding a volume in 3D space swept by the robot when making a transition in a motion planning graph from one state to another state, the transitions represented by edges in the motion planning graph. The precomputed data can, for example, be stored in memory (e.g., planning graph edge information memory) and accessed by the appropriate processor during runtime. A system can also build a family of motion planning graphs prior to runtime corresponding to different possible changing dimensional characteristics of a robot that may occur during runtime. The system then stores such planning graphs in memory.

At 402, at least one component of the processor-based system receives a kinematic model that represents the robot for which motion planning will be performed. The kinematic model, for example, represents a robotic appendage with a number of links and a number of joints, the joints between respective pairs of the links. The kinematic model can be in any known or to be developed format. Optionally, at least one component of the processor-based system generates a data structure representation of the robot based, at least in part, on the kinematic model of the robot. The data structure representation includes a representation of a number of links and joints. Various suitable data structures and techniques can be employed, for example various hierarchical data structures (e.g., tree data structures) or non-hierarchical data structures (e.g., EDF data structures). Such can, for example, employ any of the structures, methods or techniques described in PCT/US2019/045270, published as WO 2020/040979.

At 404, the processor-based system generates a motion planning graph for a robot based on the respective robot kinematic model. The motion planning graph represents each state, configuration or pose of the robot as a respective node, and represents valid transitions between pairs of states, configurations or poses as edges which connect the corresponding pair of nodes. While described in terms of a graph, the motion planning graph does not necessarily need to be represented or stored as a conventional graph, but rather can be represented, for example logically or in a memory circuit or computer processor, using any variety of data structures (e.g., records and fields, tables, linked lists, pointers, trees).

At 406, the processor-based system optionally generates a swept volume for each edge of the motion planning graph for the robot for which motion planning is to be performed. The swept volume represents a volume swept by the robot or a portion thereof in executing a motion or transition that corresponds to the respective edge. The swept volume may be represented in any of a large variety of forms, for example as voxels, a Euclidean distance field, a hierarchy of spheres or other geometric objects.

At 408, the processor-based system provides the motion planning graphs and/or the swept volumes to a robot control system and/or motion planner. The processor-based system may provide the motion planning graphs and/or the swept volumes via a non-proprietary communications channel (e.g., Ethernet). In some implementations, various robots from different robot manufacturers may operate in a shared workspace. In some implementations, various robot manufacturers may operate proprietary processor-based systems (e.g., server computers) that generate the motion planning graphs and/or the swept volumes for the various robots that the robot manufacturers produce. Each of the robot manufacturers can provide the respective motion planning graphs and/or swept volumes for use by the robot controllers or motion planners.

The processor-based systems can, for example, use any one or more of the structures and methods described in: PCT/US2019/045270, published as WO 2020/040979; PCT/US2020/034551, published as WO 2020/247207; and/or PCT/US2019/016700, published as WO 2019/156984 to produce motion planning graphs for the robot(s) for which motion planning is to be performed and/or to produce swept volumes that represent the robot(s) for which motion planning is to be performed.

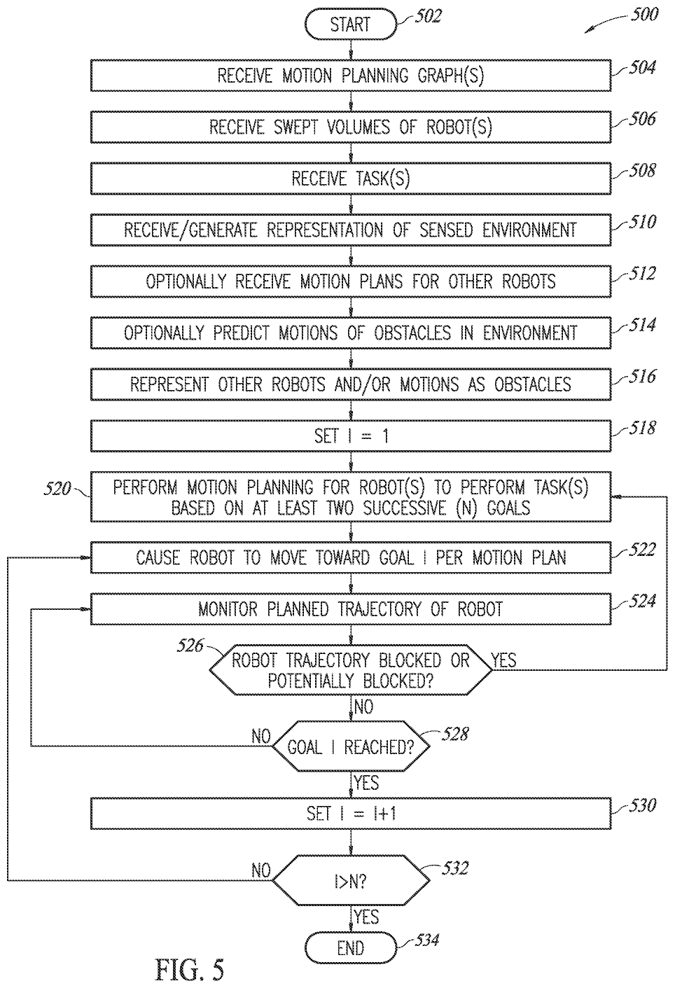

FIG. 5 shows a method 500 of operation of a processor-based system to control one or more robots, according to at least one illustrated implementation. The method 500 can be executed during a runtime of the robot(s). Alternatively, a portion of the method 500 can be executed during a configuration time, before the runtime of the robot(s), and a portion of the method 500 can be executed during the runtime of the robot(s).

The method 500 can be executed for one, two or more robots operating in a multiple robot operational environment or workspace. For example, the method 500 can be executed sequentially for each of two or more robots (e.g., a first robot R₁, a second robot R₂, a third robot R₃). For ease of discussion the method 500 is described with respect to control of a first robot R₁ where a second robot R₂ in the operational environment potentially represents an obstacle to movement of the first robot R₁. One of skill in the art will recognize from the discussion that this method can be extrapolated to control one robot where there are two or more other robots in the operational environment, or control of two or more robots where there are two or more robots in the operational environment. Such can, for instance, be performed by sequentially executing the method 500 for each robot, and/or for instance successively iteratively executing the method 500 for a given robot relative to each of the other robots that present potential obstacles to the movement of the given robot. One of skill the art will also recognize that the method 500 can omit some of the illustrated acts, include additional acts, and that many of the acts of method 500 can be executed or performed in a different order than illustrated and/or executed or performed concurrently with one another.

The method 500 can execute at a runtime, a period during which at least one of the robots is operating (e.g., moving, performing tasks) and typically two or more robots are operating, the runtime for example following a configuration time. The method 500 may be executed by one or more processor-based systems that take the form of one or more robot control systems, although the method 500 will be described with respect to one processor-based system. The robot control systems may, for example, be co-located or located “on-board” respective ones of the robots.

The method 500 starts at 502, for example in response to a powering ON of a robot and/or robot control system, in response to a call or invocation from a calling routine, or in response to receipt of a task to be performed by a robot.

At 504, the processor-based system optionally receives motion planning graph(s) for one or more robots. For example, the processor-based system may receive the motion planning graph(s) from another processor-based system, which generated the motion planning graph(s) during a configuration time, for instance as described with respect to and as illustrated in FIG. 4. The motion planning graphs represent each state, configuration or pose of the robot as a respective node, and represent valid transitions between pairs of states, configurations or poses as edges which connect the corresponding nodes. While described in terms of a graph, each motion planning graph does not necessarily need to be represented or stored as a conventional graph, but rather can be represented, for example logically or in a memory circuit or computer processor, using any variety of data structures (e.g., records and fields, tables, linked lists, pointers, trees).

At 506, the processor-based system optionally receives a set of swept volumes for one or more robots, for instance the robot R₁ for which motion is being planned, and optionally for the other robots R₂, R₃ operating in the environment. For example, the processor-based system may receive the set of swept volumes from another processor-based system, which generated the motion planning graph(s) during a configuration time, for instance as described with respect to and as illustrated in FIG. 4. Alternatively, the processor-based system may generate the set of swept volumes itself, for example based on the motion planning graphs. The swept volumes represent respective volumes swept by the robot or a portion thereof in executing a motion or translation that corresponds to a respective edge. The swept volumes may be represented in any of a large variety of forms, for example as voxels, a Euclidean distance field, a hierarchy of spheres or other geometric objects.

At 508, the processor-based system receives a number of tasks, for example in the form of task specifications. The task specifications specify robot tasks to be performed or carried out by the robots. The task specifications may, for example, specify a first task in which a robot is to move from a first position and first pose to a second position (e.g., first goal) and second pose (e.g., first goal pose), grasp an object at the second position, and a second task in which the robot is to move the object to a third position (e.g., second goal) and third pose (e.g., second goal pose) and release the object at the third position. The task specifications may take a variety of forms, for example a high level specification (e.g., prose and syntax) which requires parsing to a lower level specification. The task specifications may take the form of low level specifications, for example specifying a set of joint positions and joint angles/rotations (e.g., joint poses, joint coordinates).

At 510, the processor-based system optionally receives or generates a representation of the environment, for example a representation of the environment as sensed by one or more sensors (e.g., cameras, LIDAR). The representation can represent static or persistent objects in the environment and/or can represent dynamic or transient objects in the environment. In some implementations, one or more sensors capture and send perception data to one or more processors. The perception data can, for example, be occupancy information that represents respective locations of the obstacles in the environment. The occupancy information is typically generated by one or more sensors positioned and oriented to sense the environment in which the robot will operate or operates. The occupancy information may take the form of raw or pre-processed data, and may be formatted in any existing or later created format or schema. The perception data can, for example, be a stream that indicates which voxels or boxes are occupied by objects in the current environment. The receipt or generation of representations of the environment can occur during a period of time, for instance during an entire runtime period, and can occur periodically, aperiodically, continually and/or continuously.

For each of a number of iterations, the system receives or generates a respective discretization of a representation of an environment in which a robot 102 operates. The respective discretizations can, for example, comprise respective sets of voxels. The voxels of the respective discretizations can, for example, be non-homogenous in at least one of size and shape within the respective discretization. A respective distribution of the non-homogeneousness of the voxels of the respective discretizations can, for example, be different from one another. Obstacles may be represented digitally, for example, as bounding boxes, oriented bounding boxes, or curves (e.g., splines), whichever digital representation is most appropriate for the type of obstacle and type of collision detection that will be performed, which itself may depend on the specific hardware circuitry or software algorithm employed.

The processor-based system can, for example, represent one or more static or persistent obstacles in the environment and/or one or more dynamic or transient obstacles in the environment, including one or more other robots.

For example, at least one component of the processor-based system can receive occupancy information that represents a number of persistent obstacles in the environment and/or a number of transient obstacles in the environment. The persistent obstacles are obstacles that are generally static or remain fixed, and will not move at least during performance of one or more tasks by the robot during the runtime of the robot. The transient obstacles are obstacles that appear/enter, disappear/leave, or which are dynamic or move at least during the runtime of the robot. Thus, transient obstacles, if any, are those which, during at least some portion of the runtime have a known location and orientation in the environment and which at the configuration time did not have a known fixed location or orientation in the environment. The occupancy information may, for example, represent respective volumes occupied by each obstacle in the environment. The occupancy information may be in any known or to be developed format. The occupancy information may be generated by one or more sensors, or may be defined or specified via a computer or even by a human. The occupancy information for transient obstacles is typically received during a runtime of the robot. The persistent or static objects are sometimes identified and planned for during the configuration time, while the transient or dynamic objects are typically identified and planned for during runtime.

The at least one component of the processor-based system can generate one or more data structure representations of one or more objects or obstacles in the environment in which the robot will operate. A data structure representation can include a representation of a number of obstacles which, at a configuration time, have a known fixed location and orientation in the environment, and hence denominated as persistent in that those objects are assumed to persist in the environment at the known location and orientation from the configuration time through a run time. A data structure representation can include a representation of a number of obstacles which, at a configuration time, do not have a known fixed location and orientation in the environment and/or are expected to move during a runtime, and hence denominated as transient in that those objects are assumed to appear, disappear or move in the environment at unknown locations and orientations during a run time. Various suitable data structures, for example various hierarchical data structures (e.g., tree data structures) or non-hierarchical data structures (e.g., EDF data structures) and techniques can be employed, for example as described in PCT/US2019/045270, published as WO 2020/040979. Thus, for example, at least one component of the processor-based system receives or generates representations of obstacles in the environment as any one or more of: a Euclidean distance field, a hierarchy of bounding volumes; a tree of axis-aligned bounding boxes (AABBs), a tree of oriented (not axis-aligned) bounding boxes, a tree of spheres; a hierarchy of bounding boxes with triangle meshes as leaf nodes; a hierarchy of spheres; a k-ary sphere tree; a hierarchy of axis-aligned bounding boxes (AABB); a hierarchy of oriented bounding boxes, and/or an octree that stores voxel occupancy information. Notably, the leaves of any of the tree type data structures can be a different shape than the other nodes of the data structure, e.g., all nodes are AABBs except the root nodes or leaves which may take the form of triangle meshes. Using spheres as bounding volumes facilitates fast comparisons (i.e., it is computationally easy to determine if spheres overlap each other).

The processor-based system can, for example, use any one or more of the structures and methods described in PCT/US2019/045270, published as WO 2020/040979 to represent obstacles in the environment.

Optionally at 512, the processor-based system receives motion plans for one or more other robots, that is for robots in the environment other than the given robot for which the particular instance of motion planning is being performed. The processor-based system can advantageously use the motion plans for one or more other robots to determine whether a trajectory of a given robot (e.g., first robot R₁) will result in a collision or will have a non-zero probability of resulting in a collision with another robot (e.g., second robot R_{z}, third robot R₃), as described herein.

Optionally at 514, the processor-based system predicts motions of obstacles in the environment, for example motions or trajectories of other robots (e.g., second robot R₂, third robot R₃) in the environment. The processor-based system can, for example, extrapolate a future trajectory from a sampling of a current trajectory and/or from a knowledge or prediction of a goal of the other robot or a predicted or expected collision for the other robot. Such may be particularly useful where the motion plans for one or more other robots is not known by the processor-based system.

At 516, the processor-based system represents the other robots and/or motions of the other robots as obstacles for the robot for which the particular instance of motion planning is being performed. For example, the processor-based system may queue swept volumes corresponding to each motion as obstacles in an obstacle queue. The swept volumes may have been previously determined or calculated for each edge, and logically associated with each edge in memory via a data structure (e.g., pointer). As previously noted, the swept volumes may be represented in any of a variety of forms for example as voxels, a Euclidean distance field, a hierarchy of spheres or other geometric objects.

At 518, the processor-based system optionally initializes or sets a goal counter I to one (1), the goal counter allows the processor-based system to iterate in a loop through each of a total number of goals N.

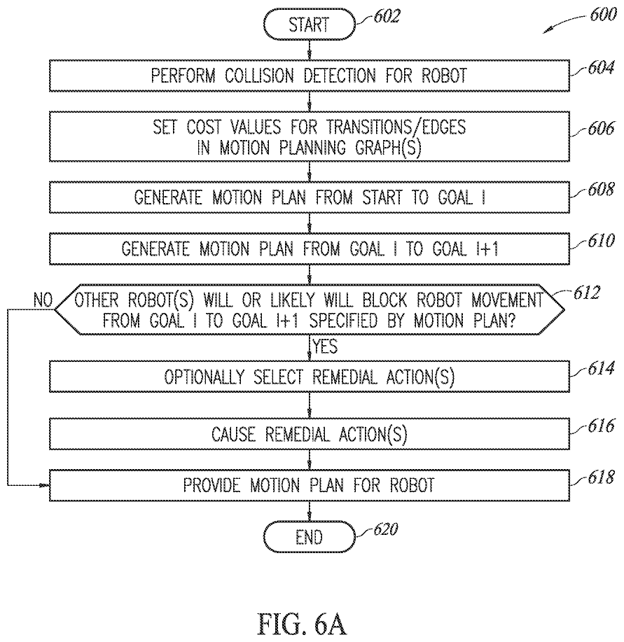

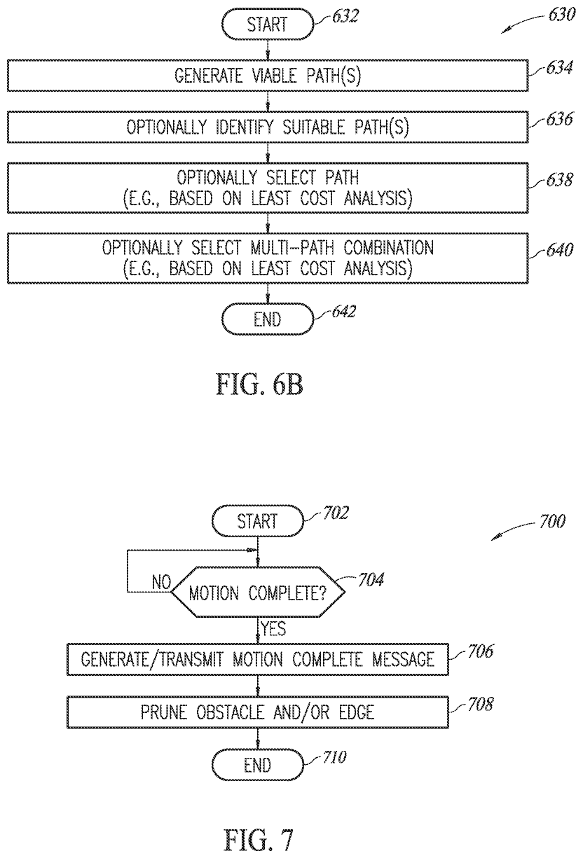

At 520, the processor-based system performs motion planning for a given robot (e.g., first robot R₁) to perform a number of tasks (e.g., one, two or more tasks), the motion planning based on a number N of at least two or more successive goals. The motion planning is performed for at least two or more successive goals before a motion specified by the resulting two or more motion plans occurs. Thus, the processor-based system can take into account a motion plan for a subsequent goal (e.g., a second goal) in assessing a compatibility with, or an adequacy of, a motion plan (e.g., a first motion plan) for a preceding goal (e.g., a first goal), and optionally implementing a remedial action if a remedial action is deemed useful or warranted (as discussed with respect to FIG. 6A, below). Such can advantageously avoid a robot from becoming trapped or even deadlocked where, for instance, a transition from a pose associated with a first goal specified by a preceding or first motion plan to a next or subsequent pose specified by a subsequent or second motion plan is blocked or will likely be blocked, for example blocked by another robot in a shared workspace. At least one implementation of motion planning is illustrated and described with reference to FIGS. 6A and 6B, below, which includes collision checking and assigning costs to edges that represent transitions in a motion planning graph. The examples of FIGS. 6A and 6B are not intended to be limiting, and other implementations of motion planning can be employed.

At 522, the processor-based system optionally controls an operation of the given robot (e.g., first robot R₁) for which the motion plan was generated, causing the given robot to move per the motion plan. For example, the processor-based system may send control signals or drive signals to one or more motion controllers (e.g., motor controllers) to cause one or more actuators to move one or more linkages according to the motion plan. It is noted that while edges typically defined valid transitions between a pair of nodes, which represent respective poses, that any edge can correspond to one, two or even more movements of the robot or portion thereof. Thus, one edge can correspond to a single movement of the robot from one to another pose in a pair of poses, or alternatively one edge can correspond to a plurality of movements of the robot from one to another pose in a pair of poses.

At 524, the processor-based system monitors the planned trajectory of the given robot (e.g., first robot R₁) for which the motion plan was generated. Monitoring can include monitoring to determine whether the robot or trajectory of the robot is blocked, for example by another robot. Monitoring can include monitoring to determine whether the given robot or trajectory of the given robot may (e.g., potentially) be blocked by a known or predicted movement of another robot, optionally including an assessment of probability of such blocking occurring. Monitoring can include monitoring to determine whether the given robot or trajectory of the given robot becomes unblocked or potentially unblocked, for example due to movement of another robot.

Monitoring can include monitoring to determine whether the given robot has reached a goal (e.g., end goal) or achieved a goal pose (e.g., end goal pose) at which a task will be completed. Monitoring can also include monitoring for completion of motions by the robot or other robots, which can advantageously allow the processor-based system to remove obstacles corresponding to the motion from consideration during subsequent collision detection or assessment. In some implementations, such can give rise to generation of a motion completed message which can be used, for instance, for pruning obstacles, as discussed below with reference to FIG. 7. The processor-based system may rely on coordinates of the corresponding robot(s). The coordinates may be based on information from the motion controllers, actuators and/or sensors (e.g., (e.g., cameras including DOF cameras and LIDAR with or without structured lighting, rotational encoders, Reed switches). In at least some implementations, monitoring for blocking or unblocking can include performing collision detection, using any of a wide variety of collision detection techniques, for example collision detection using swept volumes representing a volume swept by the given robot and/or a volume swept by other robots or other obstacles in the environment; or collision detection employing assessment of whether two spheres intersect.

At 526, the processor-based system determines or assesses whether the given robot (e.g., first robot R₁) or trajectory of the given robot has become blocked or potentially blocked, or optionally another trigger condition has occurred. For example, the processor-based system can perform collision checking for a path or trajectory of the given robot with respect to one or more objects or obstacles in the operational environment. A large variety of forms of collision checking can be employed, although such should be a relatively fast process since the collision checking is typically being performed during a runtime of the robot(s). Collision checking can, for example employ swept volumes that represent areas or volumes swept by a given robot in transitioning from one pose to another pose. Collision checking can, for example employ swept volumes that represent areas or volumes swept by other robots in transitioning from one pose to another pose. Swept volumes can advantageously be computed during a configuration time, before the runtime. Collision checking can employ the determination of the intersection of spheres which represent portions of the given robot and the obstacle(s).

If the given robot (e.g., first robot R₁) or trajectory of the given robot has become blocked or potentially blocked (e.g., with a probability of being blocked or probability of collision equal to or exceeding a defined threshold) or alternatively some other trigger condition occurs, control returns to 520. If the given robot or trajectory of the given robot is not blocked or potentially blocked (e.g., with a probability of being blocked or probability of collision below a defined threshold), control passes to 528.

At 528, the processor-based system determines whether the given robot (e.g., first robot R₁) has reached the current goal I or has achieved a goal pose that locates the robot or portion thereof at the goal I. The processor-based system may rely on coordinates of the given robot. The coordinates may be based on information from the motion controllers, actuators and/or sensors (e.g., cameras including DOF cameras and LIDAR with or with structured lighting, rotational encoders, Reed switches).

If the given robot has not reached the current goal I nor achieved the goal pose that locates the robot or portion thereof at the goal I, control returns to 522 or optionally 524, allowing the given robot to continue to move toward the current goal I according to the motion plan. If the given robot has reached the current goal I or achieved the goal pose, control passes to 530.

At 530, the processor-based system increments the goal counter (I=I+1). Control then passes to 532.

At 532, the processor-based system determines whether all of the total number of goals N have been reached (I>N) based on the goal counter. If all of total number of goals N have not been reached (I>N), control returns to 522. If all of total number of goals N have been reached (I>N), control passes to 534.

At 534, the method 500 terminates at 534, for example until invoked again. Alternatively, the method 500 may repeat until affirmatively stopped, for example by a power down state or condition. In some implementations, the method 500 may execute as a multi-threaded process on one or more cores of one or more processors.

Notably, in many implementations, the method 500 will repeat for additional tasks and/or additional robots. For example, the processor-based system can determine whether an end of a task queue and/or a motion planning request queue has been reached. For instance, the processor-based system can determine whether there are any motion planning requests remaining in a motion planning request queue, and/or whether all tasks in a task queue have been completed. In at least some implementations, a set of tasks (e.g., task queue) may be temporarily depleted, with the possibility of new or additional tasks later arriving. In such implementations, the processor-based system may execute a wait loop, checking for new or additional tasks from time-to-time or waiting for a signal indicating a new or additional task is available to be processed and carried out.

In some implementations, multiple instances of the method 500 can execute in a multithreaded process on one or more cores of one or more processors, for instance in parallel with one another. Thus, the method 500 may alternatively repeat until affirmatively stopped, for example by a power down state or condition.

While the method 500 of operation is described in terms of an ordered flow, the various acts or operations will in many implementations be performed concurrently or in parallel. Often, motion planning for one robot to perform one task may be carried out while one or more robots perform tasks. Thus, the performance of tasks by robots may overlap or be concurrent with or in parallel with the performance of motion planning by one or more motion planners. The performance of tasks by robots may overlap or be concurrent with or in parallel with the performance of tasks by other robots. In some implementations, at least some portion of motion planning for one robot may overlap or be concurrent with or in parallel with at least some portion of motion planning for one or more other robots.

FIG. 6A shows a high level method 600 of operation of a processor-based system to perform motion planning for one or more robots, according to at least one illustrated implementation. The method 600 can be executed during a runtime of the robot(s). Alternatively, a portion of the method 600 can be executed during a configuration time, before the runtime of the robot(s), and a portion of the method 600 can be executed during the runtime of the robot(s). The method 600 can, for example, be executed in performing the motion planning 520 of the method 500 (FIG. 5), although the motion planning 520 is not limited to that described and illustrated in the method 600.

The method 600 can be executed for one, two or more robots operating in a multiple robot operational environment. For example, the method 600 can be executed sequentially for each robot (e.g., a first robot R₁, a second robot R₂, a third robot R₃ or even more robots). For ease of discussion the method 600 is described with respect to control of a given robot (e.g., first robot R₁) where other robots (e.g., second robot R₂, third robot R₃) in the operational environment potentially represent obstacles to movement of the given robot (e.g., first robot R₁). One of skill in the art will recognize from the discussion herein that this method 600 can be extrapolated to motion planning for one robot where there are two or more other robots in the operational environment, or motion plan for two or more robots where there are two or more other robots in the operational environment. Such can, for instance, be performed by sequentially executing the method 600 for each robot, and/or for instance successively iteratively executing the method 600 for a given robot relative to each of the other robots that present potential obstacles to the movement of the given robot. One of skill the art will also recognize that the method 600 can omit some of the illustrated acts, include additional acts, and that many of the acts of method 600 can be executed or performed in a different order than illustrated and/or executed or performed concurrently with one another.

The method 600 can execute at a runtime, a period during which at least one of the robots is operating (e.g., moving, performing tasks), the runtime for example following a configuration time. The method 600 may be executed by one or more processor-based systems that take the form of one or more robot control systems. The robot control systems may, for example, be co-located or located “on-board” respective ones of the robots.

The method 600 starts 602, for example in response to a powering ON of a robot and/or robot control system, in response to a call or invocation from a calling routine such as a call from a calling a routine executing the method 500, in response to receipt of a motion planning request or a motion planning request in a queue of motion planning requests to be performed for a robot, or in response to receipt of a task to be performed by a robot.

At 604, the processor-based system performs collision detection or assessment for a given robot (e.g., first robot R₁). The processor-based system may employ any of the various structures and algorithms described herein or in the materials incorporated by reference herein or described elsewhere to perform the collision detection or assessment. Collision detection or assessment may include performing collision detection or assessment for each motion against each obstacle in an obstacle queue. Examples of collision assessment are described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; U.S. Patent Application 62/722,067, filed Aug. 23, 2018 entitled “COLLISION DETECTION USEFUL IN MOTION PLANNING FOR ROBOTICS”; in International Patent Application Publication No. WO 2016/122840, filed Jan. 5, 2016, entitled “SPECIALIZED ROBOT MOTION PLANNING HARDWARE AND METHODS OF MAKING AND USING SAME”; and PCT/US2019/045270, published as WO 2020/040979, to produce motion planning graphs, to produce swept volumes, and/or to perform collision checking (e.g., intersection of spheres assessments). As described herein, the processor-based system can use the collision assessment to set cost values or cost functions or as part of setting cost values or cost functions for the various edges of the motion planning graph, which can be used in generating a motion plan that specifies a suitable path (e.g., an ordered set of poses) of a robot to accomplish a task.

At 606, the processor-based system sets cost values or cost functions of the edges in the motion planning graph based at least in part on the collision detection or assessment for the given robot (e.g., first robot R₁). Cost values or cost functions can be representative of a collision assessment or risk (e.g., probability or occurrence) of collision. Cost values can additionally be representative of a severity (e.g., magnitude of damage that would result) of a collision should a collision occur. For instance, a collision with a human or other animate object may be considered as more severe, and hence more costly, than collision with a wall or table or other inanimate object. Cost values or cost functions can additionally be representative of a use or consumption of resources associated with a transition corresponding to the respective edge, for instance an amount of energy that will be consumed or an amount of time that will be incurred in executing the associated transition. The processor-based system may employ any of the various structures and algorithms described herein or in the materials incorporated by reference herein to perform the cost value or cost function setting, typically setting or adjusting the cost for edges with no or with low risk of collision to a relatively low value (e.g., zero), and setting or adjusting the cost for edges that will result in collision or with a high risk of collision to a relatively high value (e.g., one hundred thousand). The processor-based system can, for example, set cost values or cost functions of edges in the motion planning graph by logically associating each with an associated cost value or cost function via one or more data structures.

At 608, the processor-based system generates a motion plan (e.g., first motion plan) that specifies a set of valid transitions to transition or move the given robot from a start or current configuration to a first goal I. The first motion plan represents a viable path, and in at least some instances a suitable path (e.g., complete path that satisfies specified criteria for instance having a cost below a threshold cost) or even a selected path (e.g., best path, for instance a complete path having a lowest cost of all paths) between the start and the first goal I. Thus, the motion plan specifies a trajectory for the given robot through various poses corresponding to respective nodes to transition between a start and a goal. An exemplary implementation of generation of a motion plan is illustrated and described with reference to FIG. 6B, below.

At 610, the processor-based system generates a motion plan (e.g., second motion plan) that specifies a set of valid transitions to transition or move the given robot from the first goal I to a second goal I+1. The second motion plan represents a viable path, and in at least some instances a suitable path (e.g., complete path that satisfies specified criteria for instance having a cost below a threshold cost) or even a selected path (e.g., best path, for instance a complete path having a lowest cost of all paths) between the first goal I and the second goal I+1. Thus, the motion plan specifies a trajectory for the given robot through various poses corresponding to respective nodes to transition between the first goal and a second goal. An exemplary implementation of generation of a motion plan is illustrated and described with reference to FIG. 6B, below.

It is noted that in some implementations, the processor-based system can repeat generation of subsequent motion plans for any number of subsequent goals (e.g., I+2, I+3, I+4), for example to allow a deeper consideration or exploration of the effects that an earlier motion plan for a given robot will have on the ability to achieve or reach one or even more subsequent goals by the given robot.

At 612, the processor-based system determines or assesses whether other robot(s) will or likely will (i.e., a relatively high probability) block the given robot or movement of the given robot from a preceding goal (e.g. the first goal I) to a subsequent or next goal (e.g., second goal I+1) as the given robot moves along a trajectory as specified by the corresponding motion plan (e.g., second motion plan). For example, the processor-based system can determine whether the given robot will be trapped, delayed or even deadlocked in transition from a preceding motion plan (e.g., first motion plan) to a subsequent (alternatively referred to as a “next” or a “following”) motion plan (e.g., second motion plan). For example, the processor-based system can determine whether the given robot will be blocked or likely blocked from transitioning from a pose in which the given robot will be when located at the first goal per the first motion plan and a pose in which the given robot will be during at least an initial portion of the execution of the second motion plan. For instance, the processor-based system can determine whether a given robot will or likely will be prevented from executing a subsequent motion plan (e.g., a next or following motion plan) due to being blocked by another robot. Also for instance, the processor-based system can determine whether a given robot will or likely will be delayed in executing a subsequent motion plan (e.g., a next or following motion plan) due to being blocked by another robot. In at least some instances, the delay can be any delay, e.g., any amount of delay other than no delay in the ability to execute a subsequent or second motion plan once commanded to execute the subsequent or second motion plan. In other instances the delay can be a delay longer than a specified or threshold duration of delay, e.g., a specified non-zero amount of delay in the ability to execute a subsequent or second motion plan once commanded to execute the subsequent or second motion plan).

The processor-based system can, for example, employ collision detection to determine or assess whether other robot(s) will or likely will block the given robot or movement of the given robot to a subsequent goal (e.g., second goal I+1) as the given robot moves along a trajectory as specified by the corresponding motion plan (e.g., second motion plan). For example, a probability of collision that exceeds a threshold probability of collision or a cost value or cost function that exceeds a threshold cost or cost value may be indicative of a blocking condition. Various collision detection approaches can be employed, for example as described elsewhere herein. If another robot or robots will or likely will block the given robot or movement of the given robot to a goal, control passes to 614. If another robot or robots will not or likely will not (i.e., a relatively low probability) block the given robot or movement of the given robot to a goal, control passes to 618.

Optionally at 614, the processor-based system selects one or more remedial actions to take in response to a determination that the given robot will or will likely be blocked in attempting to transition from a preceding goal (e.g. the first goal I) to a subsequent or following or next goal (e.g., second goal I+1) as the given robot moves along a trajectory as specified by the corresponding motion plan (e.g., second motion plan).

An example of a remedial action includes generating a new or revised or replacement motion plan to transition the given robot to the preceding goal (e.g., generating a new or revised or replacement first motion plan). A new or revised or replacement motion plan can, for example, position the given robot or portion thereof at a first goal location, volume, region or space, but in a different goal pose than a goal pose in which the previously generated first motion plan would have placed the given robot. The different goal pose may make it easier for the given robot to transition to the subsequent goal (e.g., second goal I+1), thereby avoiding becoming trapped or even deadlocked. In at least some implementations, in generating a new or revised or replacement motion plan (e.g., generating a new or revised or replacement first motion plan) for the given robot, the processor-based system can be biased or otherwise caused to generate the new or revised or replacement motion plan with a different goal pose than the goal pose of the previously generated motion plan (e.g., first motion plan) for the given robot. Such could, for instance, be achieved by, at least temporarily, increasing a cost associated with edges connected to the node corresponding to an end pose of the previously generated motion plan for the given robot.

The processor-based system can, optionally, select between the first motion plan and at least one or more revised motion plans based, for instance, at least in part on a comparison of a respective amount of delay associated with each of the first motion plan and at least one or more revised motion plans. For example, a first motion plan may be associated with a first amount of delay (e.g., 90 seconds) during which time a given robot will be blocked or likely blocked by another robot and hence stuck at a first goal in a first end pose before being able to execute a second motion plan. Also for example, a first revised motion plan may be associated a second amount of delay (e.g., 60 seconds) during which time the given robot will be blocked or likely blocked by another robot and hence stuck at the first goal in a second end pose before being able to execute the second motion plan. In such an example, the processor-based system can select the first revised motion plan for execution by the first robot since that will result in the least delay of the available options. As a further example, a second revised motion plan may be associated a third amount of delay (e.g., 15 seconds) during which time the given robot will be blocked or likely blocked by another robot and hence stuck at the first goal in a third end pose before being able to execute the second motion plan. In such an example, the processor-based system can select the second revised motion plan for execution by the first robot since that will result in the least delay of the available options. While the selections are illustrated based solely on delay, duration or latency, the processor-based system can factor in other parameters, for example risk or probability of collision, severity of collision, and/or expenditure of energy.

Another example of a remedial action includes causing another robot to move if the other robot is blocking or will likely block the given robot. Such can, for example, include causing the other robot to move out of the way or to otherwise move so as to not block the given robot in moving along a trajectory specified by the generated motion plan(s) (e.g., first motion plan, the second motion plan) for the given robot.

Yet another example of a remedial action includes generating a new, revised or replacement motion plan for another robot that has a trajectory or planned trajectory that would block or likely block the given robot, for example to cause the other robot to move in a way in which the other robot will not block or will likely not block movement of the given robot along a trajectory specified by the generated motion plan(s) (e.g., first motion plan, the second motion plan) for the given robot.

Yet a further example of a remedial action includes determining or generating a new order of a set of goals, the set of goals including the first goal and at least the second goal. Thus what was a first goal can become a second goal and what was a second goal can become the first goal.

Optionally at 616, the processor-based system causes one or more of the remedial actions to be taken. Such can, for example, include the processor-based system invoking another iteration of motion planning for the given robot. Such can, for example, alternatively or additionally include the processor-based system invoking another iteration of motion planning for one or more other robots that are blocking or that are likely to block movement of the given robot. Such can, for example, alternatively or additionally include the processor-based system sending or transmitting control signals or drive signals to one or more motion controllers (e.g., motor controllers) to cause one or more actuators to move one or more linkages of one or more other robots to move the other robots from blocking or likely blocking the given robot. Such can, for example, alternatively or additionally include determining or generating a new order of a set of goals, the set of goals including the first goal and at least the second goal.

At 618, the processor-based system provides a motion plan implementing the selected path (e.g., selected path, selected viable path, selected suitable path, selected suitable viable path) in order to control operation of the given robot (e.g., first robot R₁) for which the motion plan was generated. For example, the processor-based system may send control signals or drive signals to one or more motion controllers (e.g., motor controllers) to cause one or more actuators to move one or more linkages to cause the given robot or portion thereof (e.g., appendage, end effector, end of arm tool) to move along a trajectory specified by the motion plan.

The method 600 may terminate at 620, for example until invoked again. Alternatively, the method 600 may repeat until affirmatively stopped, for example by a power down state or condition. In some implementations, the method 600 may execute as a multi-threaded process on one or more cores of one or more processors.

While the method 600 of operation is described in terms of an ordered flow, the various acts or operations will in many implementations be performed concurrently or in parallel. Often, motion planning for one robot to perform one task may be carried out while one or more robots perform tasks. Thus, the performance of tasks by robots may overlap or be concurrent with or in parallel with the performance of motion planning by one or more motion planners. The performance of tasks by robots may overlap or be concurrent with or in parallel with the performance of tasks by other robots. In some implementations, at least some portion of motion planning for one robot may overlap or be concurrent with or in parallel with at least some portion of motion planning for one or more other robots.

FIG. 6B shows a low level method 630 of operation of a processor-based system to perform motion planning for one or more robots, according to at least one illustrated implementation. The method 630 can be executed during a runtime of the robot(s). Alternatively, a portion of the method 630 can be executed during a configuration time, before the runtime of the robot(s), and a portion of the method 630 can be executed during the runtime of the robot(s). The method 630 can, for example, be executed in performing the motion planning 520 of the method 500 (FIG. 5), although the motion planning 520 is not limited to that described and illustrated in the method 630.

The method 630 can be executed for one, two or more robots operating in a multiple robot operational environment. For example, the method 630 can be executed sequentially for each robot (e.g., a first robot R₁, a second robot R₂, a third robot R₃ or even more robots). For ease of discussion the method 630 is described with respect to control of a given robot (e.g., first robot R₁) where other robots (e.g., second robot R₂, third robot R₃) in the operational environment potentially represent obstacles to movement of the first robot. One of skill in the art will recognize from the discussion herein that this method 630 can be extrapolated to motion planning for one robot where there are two or more other robots in the operational environment, or to motion planning for each of two or more robots where there are one, two or more other robots in the operational environment. Such can, for instance, be performed by sequentially executing the method 630 for each robot, and/or for instance successively iteratively executing the method 630 for a given robot relative to each of the other robots that present potential obstacles to the movement of the given robot. One of skill the art will also recognize that the method 630 can omit some of the illustrated acts, include additional acts, and that many of the acts of method 630 can be executed or performed in a different order than illustrated and/or executed or performed concurrently with one another.

The method 630 can execute at a runtime, a period during which at least one of the robots is operating (e.g., moving, performing tasks), the runtime for example following a configuration time. The method 630 may be executed by one or more processor-based systems that take the form of one or more robot control systems. The robot control systems may, for example, be co-located or located “on-board” respective ones of the robots.

The method 630 starts at 632, for example in response to a powering ON of a robot and/or robot control system, in response to a call or invocation from a calling routine such as a routine executing the method 500 or a routine executing the method 600, in response to receipt of a motion planning request or a motion planning request in a queue of motion planning requests to be performed for a robot, or in response to receipt of a task to be performed by a robot.

At 634, the processor-based system generates one or more viable paths using the motion planning graph. The viable paths are complete paths that extend from either a starting or current node through a goal node via valid transitions. A viable path specifies a possible trajectory for the given robot through various poses corresponding to respective nodes.

It is noted that one or more of the generated viable paths may not be a suitable viable path, for instance because a cost or cost function of a transition or edge along the path or even an accumulated cost or accumulated cost function along the path is too high (e.g., above a threshold cost or value or magnitude). The processor-based system may eventually reject those viable paths as not being suitable for performing a particular task by the given robot, even if performance of that task via transitions defined by that path is feasible and thus viable. Thus, as discussed below with reference to 636, the processor-based system can optionally identify one or more suitable viable paths from the set of one or more viable paths, for instance based on a cost threshold. Further, as discussed below with reference to 638, the processor-based system can select one of the viable paths, or even select one of the suitable viable paths when such are identified, for instance via a least cost analysis to identify a selected path (alternatively referred to as a selected viable path).

Optionally at 636, the processor-based system identifies one or more suitable paths (also interchangeably referred to as suitable viable paths or identified suitable viable paths) from one or more viable paths. The processor-based system can, for example, identify a set of viable paths that each have an associated accumulated cost across the respective viable path that is equal to or below a threshold cost. Thus, the set of suitable viable paths can include those viable paths that satisfy some defined cost condition or constraint. As noted elsewhere, cost can reflect a variety of parameters including, for example, risk or probability of collision, severity of collision, energy expenditure, duration or latency of execution or completion of the path or assigned task. The processor-based system can enforce other conditions or constraints in addition to or in lieu of the cost condition in identifying the suitable viable paths.

Optionally at 638, the processor-based system selects a path, referred to as a selected path. The processor-based system can, for example select a path from one or more viable paths (hence interchangeably referred to as a selected viable path). The processor-based system can, for example optionally select a path from the one or more identified suitable paths (hence interchangeably referred to as the selected suitable path or the selected suitable viable path). The processor-based system can, for example, perform a least cost analysis on a set of viable paths or the set of suitable paths to find a selected path that has either the least cost of all of the viable paths or a relatively low cost of all of the viable paths. Since cost or cost function is representative at least in part on the collision checking, selecting a path is based, at least in part, on the collision detection or assessment (e.g., risk or probability of collision). A cost value or cost function can additionally be representative of other criteria and/or parameters, for instance severity of a collision should a collision occur, expenditure of energy, and/or expenditure of time, etc. in executing the corresponding motions. The processor-based system may employ any of the various structures and algorithms described herein or in the materials incorporated by reference herein to select a path (e.g., selected path, selected viable path, selected suitable path, selected suitable viable path), for example via performing a least cost analysis on the viable paths or the suitable paths generated from the motion planning graph with associated cost values.

Optionally at 640, the processor-based system selects a multi-path combination or multi-motion plan combination, for instance a combination of a preceding path or preceding motion plan (e.g., first path or first motion plan) and a subsequent path or subsequent motion plan (e.g., second path or second motion) based on one or more parameters (e.g., aggregate or total cost over the combination).

The processor-based system can, for example, generate a first set of candidate paths or candidate motion plans that each specify a complete path between a current or start and a first goal. Additionally or alternatively, the processor-based system can, for example, generate a second set of candidate paths or candidate motion plans that each specify a complete path between the first goal and a subsequent, following or second goal. The processor-based system can, for example, select one path or motion plan from the first set and/or select one path or motion plan from the second set, based on one or more criteria.

The processor-based system can, for example, perform a least cost analysis on various combinations, each combination which includes a first path or first motion from the first set of candidates and a second path or second motion plan from the second set of candidates, to find a combination that has the least total aggregate cost or that has a relatively low total aggregate cost from a current or starting pose to an N^{th} goal, where N is an integer that is equal to or greater than 2. Since cost or cost function is representative at least in part on the collision checking, selecting a combination is based, at least in part, on the collision detection or assessment (e.g., risk or probability of collision). A cost value or cost function can additionally be representative of other criteria and/or parameters, for instance severity of a collision should a collision occur, expenditure of energy, and/or expenditure of time, etc. in executing the corresponding motions. The processor-based system may employ any of the various structures and algorithms described herein or in the materials incorporated by reference herein to select a path (e.g., selected path, selected viable path, selected suitable path, selected suitable viable path), for example via performing a least cost analysis on the viable paths or the suitable paths generated from the motion planning graph with associated cost values.

While not explicitly illustrated, a combination can be identified and selected to minimize a total aggregate number of poses or transitions experienced in reaching two or more goals. In some instances, such can advantageously minimize latency and/or energy expenditure. It is noted that a duration of time and/or energy expenditure to transition between any given pair of poses may not necessarily be equal to that for some other pair of poses, thus minimizing the total aggregate number of poses or transitions may not necessarily limit or reduce latency and/or energy expenditure.

The method 630 may terminate at 642, for example until invoked again. Alternatively, the method 630 may repeat until affirmatively stopped, for example by a power down state or condition. In some implementations, the method 630 may execute as a multi-threaded process on one or more cores of one or more processors.

While the method 630 of operation is described in terms of an ordered flow, the various acts or operations will in many implementations be performed concurrently or in parallel. Often, motion planning for one robot to perform one task may be carried out while one or more robots perform tasks. Thus, the performance of tasks by robots may overlap or be concurrent with or in parallel with the performance of motion planning by one or more motion planners. The performance of tasks by robots may overlap or be concurrent with or in parallel with the performance of tasks by other robots. In some implementations, at least some portion of motion planning for one robot may overlap or be concurrent with or in parallel with at least some portion of motion planning for one or more other robots.

FIG. 7 shows an optional method 700 of operation in a processor-based system to control operation of one or more robots in a multi-robot environment, according to at least one illustrated implementation. The method 700 may be executed as part of performance of the method 500 (FIG. 5) and/or performance of the method 600 (FIGS. 6A-6B), for example during a runtime of one or more robots. The method 700 may be executed by one or more processor-based systems that take the form of one or more robot control systems. The robot control systems may, for example, be co-located or “on-board” respective ones of the robots.

The method 700 starts at 702, for example in response to a power ON of a robot and/or robot control system, in response to a call or invocation from a calling routine (e.g., method 500), or in response to receipt of a set or list or queue of tasks.

Optionally at 704, the processor-based system optionally determines whether a corresponding motion has been completed. Monitoring completion of motions can advantageously allow the processor-based system to remove obstacles corresponding to the motion from consideration during subsequent collision detection or assessment. The processor-based system may rely on coordinates of the corresponding robot. The coordinates may be based on information from the motion controllers, actuators and/or sensors (e.g., cameras, rotational encoders, Reed switches) to determine whether a given motion has been completed.

Optionally at 706, the processor-based system generates or transmits a motion completed message in response to a determination that a given motion has been completed. Alternatively, the processor-based system can set and reset a flag.

At 708, the processor-based system (e.g., obstacle pruner 260, FIG. 2) prunes one or more obstacles corresponding to the given motion in response to a determination that a motion completed message has been generated or received or flag set. For example, the processor-based system may remove the corresponding obstacle from an obstacle queue. This advantageously allows collision detection or assessment to proceed with the environment cleared of a swept volume or other representation (e.g., sphere, bounding box) that is no longer present as an obstacle. Also for example, the processor-based system may remove a swept volume corresponding to an edge that represents the completed movement of a given robot. This also advantageously allows motions and corresponding swept volumes to be tracked without the need to track timing of the motions or corresponding swept volumes.

The method 700 may terminate at 710, for example until invoked again. Alternatively, the method 700 may repeat until affirmatively stopped, for example by a power down state or condition. In some implementations, the method 700 may execute as a multi-threaded process on one or more cores of one or more processors.

### Examples

Example 1. A method of operation of a processor-based system to control one or more robots in a multi-robot environment, the method comprising:
for a first robot of the one or more robots,
for a first goal, performing motion planning, by at least one processor, for the first robot to determine a first motion plan for the first robot, the motion planning taking into account at least a second robot of the one or more robots, the first motion plan which specifies a plurality of poses to transition the first robot from one pose to a first end pose, the first end pose which locates at least a portion of the first robot at the first goal;
for a second goal, performing motion planning, by at least one processor, for the first robot to attempt to determine a second motion plan for the first robot, the motion planning taking into account at least the second robot of the one or more robots, the second motion plan which specifies a plurality of poses to transition the first robot from the first end pose to a second end pose, the second end pose which locates at least a portion of the first robot at the second goal; and
causing the first robot to move after said performing motion planning for the first robot to attempt to determine the second motion plan for the first robot.

Example 2. The method of example 1 wherein performing motion planning for the first robot includes determining whether the first robot moving along a trajectory would result in a collision with the second robot or has a probability of resulting in a collision with the second robot that exceeds a threshold probability.

Example 3. The method of example 2, further comprising:
in response to determining that a trajectory of the first robot would result in a collision with the second robot or has a probability of resulting in a collision with the second robot that exceeds a threshold probability, causing the second robot to move out of a path of the first robot.

Example 4. The method of example 2, further comprising:
in response to determining that a trajectory of the first robot would result in a collision with the second robot or has a probability of resulting in a collision with the second robot that exceeds a threshold probability, causing the second robot to move out of a path of the first robot as specified by at least one of the first motion plan for the first robot or the second motion plan for the first robot.

Example 5. The method of example 2, further comprising:
in response to determining that a trajectory of the first robot would result in a collision with the second robot or has a probability of resulting in a collision with the second robot that exceeds a threshold probability, performing motion planning, by at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

Example 6. The method of example 5, further comprising:
causing the first robot to move according to the revised motion plan for the first robot.

Example 7. The method of example 1 wherein performing motion planning for the first robot includes determining whether the first robot moving along a first trajectory would result in a collision with the second robot moving along a second trajectory or has a probability of resulting in a collision with the second robot moving along a second trajectory that exceeds a threshold probability.

Example 8. The method of example 7, further comprising:
in response to determining that the first robot moving along a first trajectory would result in a collision with the second robot moving along a second trajectory or has a probability of resulting in a collision with the second robot moving along a second trajectory that exceeds a threshold probability, performing motion planning, by at least one processor, for the second robot to determine a motion plan for the second robot, the motion plan for the second robot which specifies at least one pose to transition the second robot out of a path of the first robot; and
causing the second robot to move according to the second trajectory for the second robot.

Example 9. The method of example 7, further comprising:
in response to determining that the first robot moving along a first trajectory would result in a collision with the second robot moving along a second trajectory or has a probability of resulting in a collision with the second robot moving along a second trajectory that exceeds a threshold probability, performing motion planning, by at least one processor, for the first robot to determine a revised motion plan for the first robot, the motion planning taking into account at least the second trajectory of the second robot of the one or more robots, the revised motion plan which specifies a plurality of poses to transition the first robot from one pose to the first end pose while avoiding collision or at least reducing a probability of collision with the second robot as the second robot moves along the second trajectory of the second robot, the first end pose which locates at least a portion of the first robot at the first goal.

Example 10. The method of example 9, further comprising:
causing the first robot to move according to the revised motion plan for the first robot.

Example 11. The method of any of examples 1 through 10 wherein causing the first robot to move includes causing the first robot to move to the first goal after said performing motion planning for the first robot to attempt to determine the second motion plan for the first robot.

Example 12. The method of any of examples 1 through 10 wherein causing the first robot to move includes causing the first robot to move to the second goal after causing the first robot to move to the first goal.

Example 13. The method of any of examples 1 through 10, further comprising:
for a third goal, performing motion planning, by at least one processor, for the first robot to attempt to determine a third motion plan for the first robot, the motion planning taking into account at least the second robot of the one or more robots, the third motion plan which specifies a plurality of poses to transition the first robot from the second end pose to a third end pose, the third end pose which locates at least a portion of the first robot at the third goal; and
wherein the causing the first robot to move occurs after said performing motion planning for the first robot to attempt to determine the third motion plan for the first robot.

Example 14. The method of any of examples 1 through 10 wherein performing motion planning for the first robot comprises:
representing at least the second robot as at least one obstacle; and
performing collision detection, by at least one processor, for at least one motion of at least a portion of the first robot with respect to the representation of the at least one obstacle.

Example 15. The method of any of examples 1 through 10 wherein performing motion planning for the first robot comprises:
representing a number of motions of at least the second robot as at least one obstacle; and
performing collision detection, by at least one processor, for at least one motion of at least a portion of the first robot with respect to the representation of the at least one obstacle.

Example 16. The method of example 15 wherein representing a number of motions of at least the second robot as obstacles includes: using a set of swept volumes, the swept volumes each of which represents a respective volume swept by at least a portion of the second robot as the portion of the second robot moves along a trajectory represented by the respective motion.

Example 17. The method of example 16, further comprising:
receiving the set of swept volumes, by at least one processor, which were previously computed at a pre-runtime, the swept volumes each of which represents a respective volume swept by at least a portion of the second robot as the portion of the second robot moves along a trajectory represented by the respective motion.

Example 18. The method of example 15 wherein representing a number of motions of the second robot as obstacles includes: representing the motions of the robot as at least one of: an occupancy grid, a hierarchical tree or a Euclidean distance field.

Example 19. The method of any of examples 1 through 10, further comprising:
for each of at least the first robot and the second robot, generating a respective motion planning graph, by at least one processor, each motion planning graph comprising a plurality of nodes and edges, the nodes which represent respective states of the respective first and second robots and the edges which represent valid transitions between respective states represented by the respective ones of a respective pair of nodes connected by the respective edges.

Example 20. The method of any of examples 1 through 10 wherein the performing motion planning for the first robot to determine a first motion plan for the first robot and the performing motion planning for the first robot to attempt to determine a second motion plan for the first robot both occur during a runtime of at least one of the one or more robots.

Example 21. The method of any of examples 1 through 10, further comprising:
in response to determining that a trajectory of the first robot would result in a collision with the second robot or has a probability of resulting in a collision with the second robot that exceeds a threshold probability, taking a remedial action by the at least one processor.

Example 22. The method of example 21, further comprising:
autonomously selecting, by the at least one processor, the remedial action to take out of a set of two or more defined remedial actions.

Example 23. The method of any of examples 21 or 22 wherein taking a remedial action by the at least one processor includes taking at least one of the following remedial actions: i) performing motion planning, by the at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) causing the second robot to move out of a path of the first robot as specified by at least one of the first motion plan for the first robot or the second motion plan for the first robot; ill) performing motion planning, by the at least one processor, for the second robot to determine a revised motion plan for the second robot, the revised motion plan which specifies a plurality of poses to transition the second robot out of a path of the first robot; and iv) determining a new order of a set of goals, the set of goals including the first goal and at least the second goal.

Example 24. The method of any of examples 1 through 10, further comprising:
autonomously selecting, by the at least one processor, a motion plan from a set of two or more candidate motion plans based, at least in part, on an aggregate cost of two or more motion plans across respective ones of two or more goals.

Example 25. A processor-based system to control one or more robots, the system comprising:
at least one processor;
at least one nontransitory processor-readable medium communicatively coupled to the at least one processor and which stores processor-executable instructions which, when executed by the at least one processor, cause the at least one processor to:
execute the method of any of examples 1 through 24.

Example 26. A processor-based system to control one or more robots, the system comprising:
a first robot in a robotic environment;
at least a second robot in the robotic environment;
at least one processor; and
at least one nontransitory processor-readable medium communicatively coupled to the at least one processor and which stores processor-executable instructions which, when executed by the at least one processor, cause the at least one processor to:
for a first robot of the one or more robots,
for a first goal, perform motion planning for the first robot to determine a first motion plan for the first robot, wherein the motion planning takes into account at least a second robot of the one or more robots, the first motion plan which specifies a plurality of poses to transition the first robot from one pose to a first end pose, the first end pose which locates at least a portion of the first robot at the first goal;
for a second goal, perform motion planning for the first robot to attempt to determine a second motion plan for the first robot, wherein the motion planning takes into account at least the second robot of the one or more robots, the second motion plan which specifies a plurality of poses to transition the first robot from the first end pose to a second end pose, the second end pose which locates at least a portion of the first robot at the second goal; and
cause the first robot to move after performing motion planning for the first robot to attempt to determine the second motion plan for the first robot.

Example 27. The processor-based system of example 26 wherein to perform motion planning for the first robot the at least one processor determines whether the first robot moving along a trajectory would result in a collision with the second robot or has a probability of resulting in a collision with the second robot that exceeds a threshold probability.

Example 28. The processor-based system of example 27 wherein the processor-executable instructions, when executed, cause the at least one processor further to:
in response to a determination that a trajectory of the first robot would result in a collision with the second robot or has a probability of resulting in a collision with the second robot that exceeds a threshold probability, cause the second robot to move out of a path of the first robot.

Example 29. The processor-based system of example 27 wherein the processor-executable instructions, when executed, cause the at least one processor further to:
in response to a determination that a trajectory of the first robot would result in a collision with the second robot or has a probability of resulting in a collision with the second robot that exceeds a threshold probability, cause the second robot to move out of a path of the first robot as specified by at least one of the first motion plan for the first robot or the second motion plan for the first robot.

Example 30. The processor-based system of example 27 wherein the processor-executable instructions, when executed, cause the at least one processor further to:
in response to a determination that a trajectory of the first robot would result in a collision with the second robot or has a probability of resulting in a collision with the second robot that exceeds a threshold probability, perform motion planning for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

Example 31. The processor-based system of example 30 wherein the processor-executable instructions, when executed, cause the at least one processor further to:
cause the first robot to move according to the revised motion plan for the first robot.

Example 32. The processor-based system of example 26 wherein to perform motion planning for the first robot the at least one processor determines whether the first robot moving along a first trajectory would result in a collision with the second robot moving along a second trajectory or has a probability of resulting in a collision with the second robot moving along a second trajectory that exceeds a threshold probability.

Example 33. The method of example 32 wherein the processor-executable instructions, when executed, cause the at least one processor further to:
in response to a determination that the first robot moving along a first trajectory would result in a collision with the second robot moving along a second trajectory or has a probability of resulting in a collision with the second robot moving along a second trajectory that exceeds a threshold probability, perform motion planning for the second robot to determine a motion plan for the second robot, the motion plan for the second robot which specifies at least one pose to transition the second robot out of a path of the first robot; and
cause the second robot to move according to the second trajectory for the second robot.

Example 34. The processor-based system of example 32 wherein the processor-executable instructions, when executed, cause the at least one processor further to:
in response to a determination that the first robot moving along a first trajectory would result in a collision with the second robot moving along a second trajectory or has a probability of resulting in a collision with the second robot moving along a second trajectory that exceeds a threshold probability, perform motion planning for the first robot to determine a revised motion plan for the first robot, the motion planning taking into account at least the second trajectory of the second robot of the one or more robots, the revised motion plan which specifies a plurality of poses to transition the first robot from one pose to the first end pose while avoiding collision or at least reducing a probability of collision with the second robot as the second robot moves along the second trajectory of the second robot, the first end pose which locates at least a portion of the first robot at the first goal.

Example 35. The processor-based system of example 34 wherein the processor-executable instructions, when executed, cause the at least one processor further to:
cause the first robot to move according to the revised motion plan for the first robot.

Example 36. The processor-based system of any of examples 26 through 35 wherein to cause the first robot to move the at least one processor causes the first robot to move to the first goal after performing motion planning for the first robot to attempt to determine the second motion plan for the first robot.

Example 37. The processor-based system of any of examples 26 through 35 wherein to cause the first robot to move the at least one processor causes the first robot to move to the second goal after causing the first robot to move to the first goal.

Example 38. The processor-based system of any of examples 26 through 35 wherein the processor-executable instructions, when executed, cause the at least one processor further to:
for a third goal, perform motion planning for the first robot to attempt to determine a third motion plan for the first robot, wherein the motion planning takes into account at least the second robot of the one or more robots, the third motion plan which specifies a plurality of poses to transition the first robot from the second end pose to a third end pose, the third end pose which locates at least a portion of the first robot at the third goal; and
wherein to cause the first robot to move occurs after performing motion planning for the first robot to attempt to determine the third motion plan for the first robot.

Example 39. The processor-based system of any of examples 26 through 35 wherein to perform motion planning for the first robot the at least one processor:
represents at least the second robot as at least one obstacle; and
performs collision detection for at least one motion of at least a portion of the first robot with respect to the representation of the at least one obstacle.

Example 40. The processor-based system of any of examples 26 through 35 wherein to perform motion planning for the first robot the at least one processor:
represents a number of motions of at least the second robot as at least one obstacle; and
performs collision detection for at least one motion of at least a portion of the first robot with respect to the representation of the at least one obstacle.

Example 41. The processor-based system of example 40 wherein to represent a number of motions of at least the second robot as obstacles the at least one processor uses a set of swept volumes, the swept volumes each of which represents a respective volume swept by at least a portion of the second robot as the portion of the second robot moves along a trajectory represented by the respective motion.

Example 42. The processor-based system of example 41 wherein the processor-executable instructions, when executed, cause the at least one processor further to:
receive the set of swept volumes, which were previously computed at a pre-runtime, the swept volumes each of which represents a respective volume swept by at least a portion of the second robot as the portion of the second robot moves along a trajectory represented by the respective motion.

Example 43. The processor-based system of example 40 wherein to represent a number of motions of the second robot as obstacles the at least one processor: represents the motions of the robot as at least one of: an occupancy grid, a hierarchical tree or a Euclidean distance field.

Example 44. The processor-based system of any of examples 26 through 35 wherein the processor-executable instructions, when executed, cause the at least one processor further to:
for each of at least the first robot and the second robot, generate a respective motion planning graph, each motion planning graph comprising a plurality of nodes and edges, the nodes which represent respective states of the respective first and second robots and the edges which represent valid transitions between respective states represented by the respective ones of a respective pair of nodes connected by the edge.

Example 45. The processor-based system of any of examples 26 through 35 wherein the performing motion planning for the first robot to determine a first motion plan for the first robot and the performing motion planning for the first robot to attempt to determine a second motion plan for the first robot both occur during a runtime of at least one of the one or more robots.

Example 46. The processor-based system of any of examples 26 through 36 wherein the processor-executable instructions, when executed, cause the at least one processor further to:
in response to a determination that a trajectory of the first robot would result in a collision with the second robot or has a probability of resulting in a collision with the second robot that exceeds a threshold probability, take a remedial action.

Example 47. The processor-based system of example 46 wherein the processor-executable instructions, when executed, cause the at least one processor further to:
autonomously select the remedial action to take out of a set of two or more defined remedial actions.

Example 48. The processor-based system of any of examples 46 or 47 wherein to take a remedial action the at least one processor causes at least one of the following remedial actions to occur: i) performance of motion planning, by at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) cause the second robot to move out of a path of the first robot as specified by at least one of the first motion plan for the first robot or the second motion plan for the first robot; iii) cause performance of motion planning for the second robot to determine a revised motion plan for the second robot, the revised motion plan which specifies a plurality of poses to transition the second robot out of a path of the first robot; and iv) determine a new order of a set of goals, the set of goals including the first goal and at least the second goal.

Example 49. The processor-based system of any of examples 26 through 36 wherein the processor-executable instructions, when executed, cause the at least one processor further to:
autonomously select a motion plan from a set of two or more candidate motion plans based, at least in part, on an aggregate cost of two or more motion plans across respective ones of two or more goals.

Example 50. A method of operation of a processor-based system to control one or more robots in a multi-robot environment, the method comprising:
performing motion planning, by at least one processor, for a first robot of the one or more robots to determine a first motion plan for the first robot, the motion planning taking into account at least a second robot of the one or more robots, the first motion plan which specifies a plurality of poses to transition the first robot from one pose to a first end pose, the first end pose which locates at least a portion of the first robot at a first goal;
performing motion planning, by at least one processor, for the first robot to attempt to determine a second motion plan for the first robot, the motion planning taking into account at least the second robot of the one or more robots, the second motion plan which specifies a plurality of poses to transition the first robot from the first end pose to a second end pose, the second end pose which locates at least a portion of the first robot at a second goal;
determining whether the first robot will be at least one of trapped, delayed or deadlocked in transitioning from the first motion plan to the second motion plan; and
in response to determining that the first robot will be at least one of trapped, delayed or deadlocked in transitioning from the first motion plan to the second motion plan, causing, by the at least one processor, execution of at least one remedial action.

Example 51. The method of example 50, further comprising:
autonomously selecting, by the at least one processor, the remedial action to take out of a set of the remedial actions.

Example 52. The method of any of examples 50 or 51 wherein causing the execution of a remedial action by the at least one processor includes causing at least one of the following remedial actions: i) performing motion planning, by the at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) causing the second robot to move out of a path of the first robot as specified by at least one of the first motion plan for the first robot or the second motion plan for the first robot; iii) performing motion planning, by the at least one processor, for the second robot to determine a revised motion plan for the second robot, the revised motion plan which specifies a plurality of poses to transition the second robot out of a path of the first robot; and iv) determining a new order of a set of goals, the set of goals including the first goal and at least the second goal.

Example 53. The method of any of examples 50 or 51 wherein causing the execution of a remedial action by the at least one processor includes causing: a further motion planning, by the at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

Example 54. The method of example 53, further comprising:
selecting between the first motion plan and at least the revised motion plan based at least in part on a comparison of a respective amount of delay associated with each of the first motion plan and at least the revised motion plan.

Example 55. The method of any of examples 50 through 54, further comprising:
causing the first robot to move after said performing motion planning for the first robot to attempt to determine the second motion plan for the first robot.

Example 56. A processor-based system to control one or more robots, the processor-based system comprising:
at least one processor;
at least one nontransitory processor-readable medium communicatively coupled to the at least one processor and which stores processor-executable instructions which, when executed by the at least one processor, cause the at least one processor to:
execute the method of any of examples 50 through 55.

Example 57. A processor-based system to control one or more robots, the processor-based system comprising:
at least one processor;
at least one nontransitory processor-readable medium communicatively coupled to the at least one processor and which stores processor-executable instructions which, when executed by the at least one processor, cause the at least one processor to:
perform motion planning for a first robot of the one or more robots to determine a first motion plan for the first robot, the motion planning taking into account at least a second robot of the one or more robots, the first motion plan which specifies a plurality of poses to transition the first robot from one pose to a first end pose, the first end pose which locates at least a portion of the first robot at a first goal;
perform motion planning for the first robot to attempt to determine a second motion plan for the first robot, the motion planning taking into account at least the second robot of the one or more robots, the second motion plan which specifies a plurality of poses to transition the first robot from the first end pose to a second end pose, the second end pose which locates at least a portion of the first robot at a second goal; and
determine whether the first robot will be at least one of trapped, delayed or deadlocked in transitioning from the first motion plan to the second motion plan; and
in response to a determination that the first robot will be at least one of trapped, delayed or deadlocked in transitioning from the first motion plan to the second motion plan, cause execution of at least one remedial action.

Example 58. The processor-based system of example 57 wherein the processor-executable instructions, when executed by the at least one processor, cause the at least one processor further to:
autonomously select the remedial action to cause out of a set of the remedial actions.

Example 59. The processor-based system of any of examples 57 or 58 wherein to cause execution of at least one remedial action, the at least one processor causes execution at least one of the following remedial actions: i) further motion planning to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) cause the second robot to move out of a path of the first robot as specified by at least one of the first motion plan for the first robot or the second motion plan for the first robot; iii) perform motion planning for the second robot to determine a revised motion plan for the second robot, the revised motion plan which specifies a plurality of poses to transition the second robot out of a path of the first robot; and iv) determine a new order of a set of goals, the set of goals including the first goal and at least the second goal.

Example 60. The processor-based system of any of examples 57 or 58 wherein to cause execution of a remedial action, the at least one processor causes a further motion planning for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

Example 61. The processor-based system of example 60 wherein the processor-executable instructions, when executed by the at least one processor, cause the at least one processor further to:
select between the first motion plan and at least the revised motion plan based at least in part on a comparison of a respective amount of delay associated with each of the first motion plan and at least the revised motion plan.

Example 62. The processor-based system of any of examples 57 through 61 wherein the processor-executable instructions, when executed by the at least one processor, cause the at least one processor further to:
cause the first robot to move after said performing motion planning for the first robot to attempt to determine the second motion plan for the first robot.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Boolean circuits, Application Specific Integrated Circuits (ASICs) and/or FPGAs. However, those skilled in the art will recognize that the embodiments disclosed herein, in whole or in part, can be implemented in various different implementations in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being implemented in hardware, for example in one or more FPGAs or ASICs.

The various embodiments described above can be combined to provide further embodiments. All of the commonly assigned US patent application publications, US patent applications, foreign patents, and foreign patent applications referred to in this specification and/or listed in the Application Data Sheet, including but not limited International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS,” International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; U.S. Patent Application Ser. No. 62/626,939, filed Feb. 6, 2018, entitled “MOTION PLANNING OF A ROBOT STORING A DISCRETIZED ENVIRONMENT ON ONE OR MORE PROCESSORS AND IMPROVED OPERATION OF SAME”, U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”, U.S. Patent Application No. 62/865,431, filed Jun. 24, 2019, entitled “MOTION PLANNING FOR MULTIPLE ROBOTS IN SHARED WORKSPACE”; International Patent Application No. PCT/US2019/016700, filed Feb. 5, 2019, entitled “MOTION PLANNING OF A ROBOT STORING A DISCRETIZED ENVIRONMENT ON ONE OR MORE PROCESSORS AND IMPROVED OPERATION OF SAME” and published as WO 2019/156984; International Patent Application No. PCT/US2020/034551, filed May 26, 2020, entitled “APPARATUS, METHODS AND ARTICLES TO FACILITATE MOTION PLANNING ENVIRONMENTS HAVING DYNAMIC OBSTACLES” and published as WO 2020/247207; International Patent Application No. PCT/US2020/039193, filed Jun. 23, 2020, entitled “MOTION PLANNING FOR MULTIPLE ROBOTS IN SHARED WORKSPACE” and published as WO 2020/263861, International Patent Application No. PCT/US2020/047429, filed Aug. 21, 2020, entitled “MOTION PLANNING FOR ROBOTS TO OPTIMIZE VELOCITY WHILE MAINTAINING LIMITS ON ACCELERATION AND JERK” and published as WO 2021041223; U.S. patent application Ser. No. 17/153,662, entitled CONFIGURATION OF ROBOTS IN MULTI-ROBOT OPERATIONAL ENVIRONMENT, filed Jan. 20, 2021 and published as US 2021/0220994; and U.S. Patent Application No. 63/318,933, filed Mar. 11, 2022, entitled “MOTION PLANNING AND CONTROL FOR ROBOTS IN SHARED WORKSPACE EMPLOYING STAGING POSES”, are incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. (canceled)

2. The method of claim 50 wherein performing motion planning for the first robot includes determining whether the first robot moving along a trajectory would result in a collision with the second robot or has a probability of resulting in a collision with the second robot that exceeds a threshold probability.

3. The method of claim 2, further comprising:
in response to determining that a trajectory of the first robot would result in a collision with the second robot or has a probability of resulting in a collision with the second robot that exceeds a threshold probability, causing the second robot to move out of a path of the first robot.

4. The method of claim 2, further comprising:
in response to determining that a trajectory of the first robot would result in a collision with the second robot or has a probability of resulting in a collision with the second robot that exceeds a threshold probability, causing the second robot to move out of a path of the first robot as specified by at least one of the first motion plan for the first robot or the second motion plan for the first robot.

5. The method of claim 2, further comprising:
in response to determining that a trajectory of the first robot would result in a collision with the second robot or has a probability of resulting in a collision with the second robot that exceeds a threshold probability, performing motion planning, by at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

6. (canceled)

7. The method of claim 50 wherein performing motion planning for the first robot includes determining whether the first robot moving along a first trajectory would result in a collision with the second robot moving along a second trajectory or has a probability of resulting in a collision with the second robot moving along a second trajectory that exceeds a threshold probability.

8. The method of claim 7, further comprising:
in response to determining that the first robot moving along a first trajectory would result in a collision with the second robot moving along a second trajectory or has a probability of resulting in a collision with the second robot moving along a second trajectory that exceeds a threshold probability, performing motion planning, by at least one processor, for the second robot to determine a motion plan for the second robot, the motion plan for the second robot which specifies at least one pose to transition the second robot out of a path of the first robot; and
causing the second robot to move according to the second trajectory for the second robot.

9. The method of claim 7, further comprising:
in response to determining that the first robot moving along a first trajectory would result in a collision with the second robot moving along a second trajectory or has a probability of resulting in a collision with the second robot moving along a second trajectory that exceeds a threshold probability, performing motion planning, by at least one processor, for the first robot to determine a revised motion plan for the first robot, the motion planning taking into at least account the second trajectory of the second robot of the one or more robots, the revised motion plan which specifies a plurality of poses to transition the first robot from one pose to the first end pose while avoiding collision or at least reducing a probability of collision with the second robot as the second robot moves along the second trajectory of the second robot, the first end pose which locates at least a portion of the first robot at the first goal.

10.-13. (canceled)

14. The method of claim 50 wherein performing motion planning for the first robot comprises:
representing at least the second robot as at least one obstacle; and
performing collision detection, by at least one processor, for at least one motion of at least a portion of the first robot with respect to the representation of the at least one obstacle.

15. The method of claim 50 wherein performing motion planning for the first robot comprises:
representing a number of motions of at least the second robot as at least one obstacle; and
performing collision detection, by at least one processor, for at least one motion of at least a portion of the first robot with respect to the representation of the at least one obstacle.

16. The method of claim 15 wherein representing a number of motions of at least the second robot as obstacles includes: using a set of swept volumes, the swept volumes each of which represents a respective volume swept by at least a portion of the second robot as the portion of the second robot moves along a trajectory represented by the respective motion.

17. The method of claim 16, further comprising:
receiving the set of swept volumes, by at least one processor, which were previously computed at a pre-runtime, the swept volumes each of which represents a respective volume swept by at least a portion of the second robot as the portion of the second robot moves along a trajectory represented by the respective motion.

18. The method of claim 15 wherein representing a number of motions of the second robot as obstacles includes: representing the motions of the robot as at least one of: an occupancy grid, a hierarchical tree or a Euclidean distance field.

19. The method of claim 50, further comprising:
for each of at least the first robot and the second robot, generating a respective motion planning graph, by at least one processor, each motion planning graph comprising a plurality of nodes and edges, the nodes which represent respective states of the respective first and second robots and the edges which represent valid transitions between respective states represented by the respective ones of a respective pair of nodes connected by the respective edges.

20.-23. (canceled)

24. The method of claim 50, further comprising:
autonomously selecting, by the at least one processor, a motion plan form a set of two or more candidate motion plans based, at least in part, on an aggregate cost of two or more motion plans across respective ones of two or more goals.

25.-49. (canceled)

50. A method of operation of a processor-based system to control one or more robots in a multi-robot environment, the method comprising:
performing motion planning, by at least one processor, for a first robot of the one or more robots to determine a first motion plan for the first robot, the motion planning taking into account at least a second robot of the one or more robots, the first motion plan which specifies a plurality of poses to transition the first robot from one pose to a first end pose, the first end pose which locates at least a portion of the first robot at a first goal;
performing motion planning, by at least one processor, for the first robot to attempt to determine a second motion plan for the first robot, the motion planning taking into account at least the second robot of the one or more robots, the second motion plan which specifies a plurality of poses to transition the first robot from the first end pose to a second end pose, the second end pose which locates at least a portion of the first robot at a second goal;
determining whether the first robot will be at least one of trapped, delayed or deadlocked in transitioning from the first motion plan to the second motion plan; and
in response to determining that the first robot will be at least one of trapped, delayed or deadlocked in transitioning from the first motion plan to the second motion plan, causing, by the at least one processor, execution of at least one remedial action.

51. The method of claim 50, further comprising:
autonomously selecting, by the at least one processor, the remedial action to take out of a set of the remedial actions.

52. The method of claim 51 wherein causing the execution of a remedial action by the at least one processor includes causing at least one of the following remedial actions: i) performing motion planning, by the at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) causing the second robot to move out of a path of the first robot as specified by at least one of the first motion plan for the first robot or the second motion plan for the first robot; iii) performing motion planning, by the at least one processor, for the second robot to determine a revised motion plan for the second robot, the revised motion plan which specifies a plurality of poses to transition the second robot out of a path of the first robot; and iv) determining a new order of a set of goals, the set of goals including the first goal and at least the second goal.

53. The method of claim 50 wherein causing the execution of a remedial action by the at least one processor includes causing: a further motion planning, by the at least one processor, for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

54. The method of claim 53, further comprising:
selecting between the first motion plan and at least the revised motion plan based at least in part on a comparison of a respective amount of delay associated with each of the first motion plan and at least the revised motion plan.

55. The method of claim 50, further comprising:
causing the first robot to move according to the first motion plan for the first robot after said performing motion planning for the first robot to attempt to determine the second motion plan for the first robot.

56. (canceled)

57. A processor-based system to control one or more robots, the processor-based system comprising:
at least one processor;
at least one nontransitory processor-readable medium communicatively coupled to the at least one processor and which stores processor-executable instructions which, when executed by the at least one processor, cause the at least one processor to:
perform motion planning for a first robot of the one or more robots to determine a first motion plan for the first robot, the motion planning taking into account at least a second robot of the one or more robots, the first motion plan which specifies a plurality of poses to transition the first robot from one pose to a first end pose, the first end pose which locates at least a portion of the first robot at a first goal;
perform motion planning for the first robot to attempt to determine a second motion plan for the first robot, the motion planning taking into account at least the second robot of the one or more robots, the second motion plan which specifies a plurality of poses to transition the first robot from the first end pose to a second end pose, the second end pose which locates at least a portion of the first robot at a second goal; and
determine whether the first robot will be at least one of trapped, delayed or deadlocked in transitioning from the first motion plan to the second motion plan; and
in response to a determination that the first robot will be at least one of trapped, delayed or deadlocked in transitioning from the first motion plan to the second motion plan, cause execution of at least one remedial action.

58. The processor-based system of claim 57 wherein the processor-executable instructions, when executed by the at least one processor, cause the at least one processor further to:
autonomously select the remedial action to cause out of a set of the remedial actions.

59. The processor-based system of claim 58 wherein to cause execution of at least one remedial action, the at least one processor causes execution at least one of the following remedial actions: i) further motion planning to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal; ii) cause the second robot to move out of a path of the first robot as specified by at least one of the first motion plan for the first robot or the second motion plan for the first robot; iii) perform motion planning for the second robot to determine a revised motion plan for the second robot, the revised motion plan which specifies a plurality of poses to transition the second robot out of a path of the first robot; and iv) determine a new order of a set of goals, the set of goals including the first goal and at least the second goal.

60. The processor-based system of claim 57 wherein to cause execution of a remedial action, the at least one processor causes a further motion planning for the first robot to determine a revised motion plan for the first robot, the motion planning taking into account at least the second robot of the one or more robots, the revised motion plan which specifies a plurality of poses to transition the first robot from one pose to the first end pose while avoiding collision or at least reducing a probability of collision with the second robot, the first end pose which locates at least a portion of the first robot at the first goal.

61. The processor-based system of claim 60 wherein the processor-executable instructions, when executed by the at least one processor, cause the at least one processor further to:
select between the first motion plan and at least the revised motion plan based at least in part on a comparison of a respective amount of delay associated with each of the first motion plan and at least the revised motion plan.

62. The processor-based system of claim 57 wherein the processor-executable instructions when executed cause the at least one processor further to:
cause the first robot to move according to the first motion plan for the first robot after said performing motion planning for the first robot to attempt to determine the second motion plan for the first robot.
